(19) United States
(12) Patent Application Publication
(10) Pub. No.: US 2007/0206713 A1
(43) Pub. Date: Sep. 6, 2007

(54) Gaming machine

(75) Inventor: Masahiro Yamaguchi, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Aruze Corp., Tokyo (JP)

(21) Appl. No.: 11/359,872

(22) Filed: Feb. 23, 2006

(51) Int. Cl. H04L 23/00

(52) U.S. Cl. 375/377

(57) ABSTRACT

Disclosed is a gaming machine. The gaming machine comprises symbol display means capable of variably displaying a plurality of symbols, and main control means for supplying power to the symbol display means, controlling states from a beginning of the variable display of the symbols to a stopping thereof in the symbol display means and carrying out a game providing a medal based on the symbol after the stopping. Further, it comprises effect means for effecting a game, sub-control means for supplying the power to the effect means and controlling the effect, and power source means for supplying the power to the main control means and the sub-control means, respectively.

### CROSS REFERENCE TO RELATED APPLICATION

This application is based upon the Japanese Patent Applications No. 2004-346194 filed on Nov. 30, 2004, No. 2004-346195 filed on Nov. 30, 2004, No. 2004-346196 filed on Nov. 30, 2004, and No. 2004-346197 filed on Nov. 30, 2004.

### BACKGROUND OF THE INVENTION

1. Field of the Invention

The present invention relates to a gaming machine capable of reducing costs and the like.

2. Description of Related Art

In general, a gaming machine is adapted to be effected by a liquid crystal device or LED lamp according to game states such as winning combination and the like. An example of the gaming machine is disclosed in a Japanese Patent Publication No. 2001-224761. As described in the patent, the gaming machine comprises a main control board controlling a winning combination, a game value to be awarded and the like, a power source board connected to the main control board to supply power, and a sub-control board supplied with the power from the main control board to control an effect, wherein the main control board and the sub-control board are supplied with the power from the power source board in series. In addition, as disclosed in a Japanese Patent Publication No. 2003-164619, there is also a gaming machine structured to supply the power to a main control board, a sub-control board and other process boards from a power source board in parallel.

In addition, as disclosed in a Japanese Patent Publication No. 2001-198274, there is a gaming machine structured to supply power to a main control board, a sub-control board and other process boards from a power source board in parallel and having a detector detecting a case that a supply voltage is lowered under a predetermined level.

However, the gaming machine disclosed in the Japanese Patent Publication No. 2001-224761 has a disadvantage in that because the main control board is supplied with the power from the power source board and the power is supplied to the sub-control board and the like from the main control board in series, the sub-control board is supplied with the voltage lowered due to a voltage drop in the main control board, thereby causing a problem in a game operation. In addition, if the power to be supplied to the main control board is reduced so as to save the costs, the sub-control board may be not operated. Further, the gaming machine disclosed in the Japanese Patent Publication No. 2003-164619 has a disadvantage in that a power supply route is complicated and a circuit arrangement is thus liable to be complicated; since the power is supplied to each process board from the power source board in parallel.

Further, the gaming machine disclosed in the Japanese Patent Publication No. 2001-198274 cannot perform the detection when the supply voltage is rapidly increased due to an illegal act of a player, a static electricity or the like, because it detects only the case that the supply voltage is lowered to a predetermined level or less. Thereby, the illegal act cannot be prevented and there is a worry that the machine may get out of order due to the rapid increase of the supply voltage. In addition, the game machine has also the disadvantage in that a power supply route is complicated and a circuit arrangement is thus liable to be complicated, since the power is supplied to each process board from the power source board in parallel.

In addition, according to recent gaming machines, since the effects by the liquid crystal display or LED lamp becomes splendid and heat is much generated in boards controlling them, it is required to suppress the heat generation. However, in the gaming machine of the Japanese Patent Publication No. 2001-224716, if the supply voltage from the power source board is lowered so as to suppress the heat generation, the sub-control board is supplied with the voltage lowered due to a voltage drop in the main control board, thereby causing a problem in a game operation. Additionally, in case that it is necessary to change only the consumption power of the sub-control board so as to make the effects more colorful, since the whole power source board should be rebuilt, there may be a sudden rise in costs.

### SUMMARY OF THE INVENTION

Accordingly, the invention has been made to solve the above-mentioned problems occurring in the prior art. A first object of the invention is to provide a gaming machine capable of reducing costs arid simplifying a power supply route or circuit arrangement, without causing a problem such as malfunction.

A second object of the invention is to provide a gaming machine capable of maintaining a supply voltage at a predetermined level or less to prevent a failure or erroneous operation and simplifying a power supply route or circuit arrangement.

A third object of the invention is to provide a gaming machine capable of suppressing a consumption power without causing a problem, and easily changing the consumption power.

According to an aspect of the invention, there is provided a gaming machine comprising symbol display means capable of variably displaying a plurality of symbols; main control means for supplying power to the symbol display means, controlling states from a beginning of the variable display of the symbols to a stopping thereof in the symbol display means and carrying out a game providing a game value based on the symbol after the stopping; effect means for effecting a game; sub-control means for supplying the power to the effect means and controlling the effect; and power source means for supplying the power to the main control means and the sub-control means, respectively.

According to the above invention, the first object can be achieved. Specifically, since the power is respectively supplied to the main control means and the sub-control means from the power source means, the power is not supplied to the sub-control means with a voltage being lowered due to a voltage drop in the main control means, as a case of supplying the power to the sub-control means via the main control means from the power source means, for example. Thereby, even when a voltage of the power, which is outputted to the main control means and the sub-control means from the power source means, is lowered, it is possible to surely operate the sub-control means and the effect means to which the power is supplied from the sub-control means. In addition, since it is possible to suppress consumption power of each means such as main control means, sub-control means or the like if the voltage is lowered, it is possible to suppress heat generation resulting from the consumption of the power, to prevent an erroneous operation of each means caused by the heat and to reduce a running cost.

In addition, since it is structured a power supply route of supplying the power to the main control means and the sub-control means from the power source means, respectively, then supplying the power to the symbol display means from the main control means and supplying the power to the effect means from the sub-control means at the same time, it is possible to simplify a wiring or circuit arrangement as compared to a power supply route of supplying the power to all the means from the power source means.

According to the invention, there is provided a gaming machine comprising symbol display means capable of variably displaying a plurality of symbols; main control means for supplying power to the symbol display means, controlling states from a beginning of the variable display of the symbols to a stopping thereof in the symbol display means and carrying out a game providing a game value based on the symbol after the stopping; effect means for effecting a game; sub-control means for supplying the power to the effect means and. controlling the effect; power source means for supplying the power to the main control means and the sub-control means, respectively; and driving voltage restriction means provided to at least input sides of the power supplied to the main control means and the sub-control means, respectively, and restricting a voltage of the power to a predetermined level or less.

According to the above invention, the second object can be achieved. Specifically, even when it is carried out an illegal act which forcibly applies a high voltage at an output side of the power source means from the exterior to cause an erroneous operation of the main control means or sub-control means, the high voltage is restricted to the predetermined level or less by the driving voltage restriction means, so that it is possible to prevent the illegal act resulting from the erroneous operations of at least the main control means and the sub-control means at the high voltage. In addition to the illegal act, it is also possible to an erroneous operation resulting from a surge voltage due to a static electricity.

Further, since the power is respectively supplied to the main control means and the sub-control means from the power source means, the power is not supplied to the sub-control means with the voltage being lowered due to a voltage drop in the main control means, as the case of supplying the power to the sub-control means via the main control means from the power source means, for example. Thereby, even when a voltage of the power, which is outputted to the main control means and the sub-control means from the power source means, is lowered, it is possible to surely operate the sub-control means and the effect means to which the power is supplied from the sub-control means. In addition, since it is possible to suppress consumption power of each means such as main control means, sub-control means or the like if the voltage is lowered, it is possible to suppress heat generation resulting from the consumption of the power, to prevent an erroneous operation of each means caused by the heat and to reduce a running cost. Additionally, since it is structured a power supply route of supplying the power to the main control means and the sub-control means from the power source means, respectively, then supplying the power to the symbol display means from the main control means and supplying the power to the effect means from the sub-control means at the same time, it is possible to simplify a wiring or circuit arrangement as compared to a power supply route of supplying the power to all the means from the power source means.

According to the invention, there is provided a gaming machine comprising symbol display means capable of variably displaying a plurality of symbols; main control means for supplying power to the symbol display means, controlling states from a beginning of the variable display of the symbols to a stopping thereof in the symbol display means and carrying out a game providing a game value based on the symbol after the stopping; effect means for effecting a game; sub-control means for supplying the power to the effect means and controlling the effect; an external concentration terminal plate having a contact unit capable of opening and closing a point of contact by power supply and making it possible to transmit and receive various signals to and from a hall computer via the contact unit; power source means for supplying the power to the main control means, the sub-control means and the external concentration terminal plate, respectively; and driving voltage restriction means provided to at least input sides of the power supplied to the main control means, the sub-control means and the external concentration terminal plate, respectively, and restricting a voltage of the power to a predetermined level or less.

According to the above invention, the second object can be achieved. Specifically, even when it is carried out an illegal act which forcibly applies a high voltage at an output side of the power source means from the exterior to cause an erroneous operation of the main control means, the sub-control means or the external concentration terminal plate, the high voltage is restricted to the predetermined level or less by the driving voltage restriction means, so that it is possible to prevent the illegal act resulting from the erroneous operations of at least the main control means, the sub-control means and the external concentration terminal plate at the high voltage. In addition to the illegal act, it is also possible to an erroneous operation resulting from a surge voltage due to a static electricity. In particular, it is possible to prevent a problem in that false data is transmitted to the hall computer through the external concentration terminal plate to cause a trouble in management.

Further, since the power is respectively supplied to the main control means, the sub-control means and the external concentration terminal plate from the power source means, the power is not supplied to the sub-control means with the voltage being lowered due to a voltage drop in the main control means, as the case of supplying the power to the sub-control means via the main control means from the power source means, for example. Thereby, even when a voltage of the power, which is outputted to the main control means and the sub-control means from the power source means, is lowered, it is possible to surely operate the sub-control means and the effect means to which the power is supplied from the sub-control means. In addition, since it is possible to suppress consumption power of each means such as main control means, sub-control means, external concentration terminal plate and the like if the voltage is lowered, it is possible to suppress heat generation resulting from the consumption of the power, to prevent an erroneous operation of each means caused by the heat and to reduce a running cost.

Additionally, since it is structured a power supply route of supplying the power to the main control means and the sub-control means from the power source means, respectively, then supplying the power to the symbol display means from the main control means and supplying the power to the effect means from the sub-control means at the same time, it is possible to simplify a wiring or circuit arrangement as compared to a power supply route of supplying the power to all the means from the power source means.

According to the invention, there is provided a gaming machine comprising symbol display means capable of variably displaying a plurality of symbols; main control means for supplying power to the symbol display means, controlling states from a beginning of the variable display of the symbols to a stopping thereof in the symbol display means and carrying out a game providing a game value based on the symbol after the stopping; effect means for effecting a game; sub-control means for supplying the power to the effect means and controlling the effect; and power source means having a main control power source unit and a sub-control power source unit for independently supplying the power to the main control means and the sub-control means and the external concentration terminal plate, respectively.

According to the above invention, the third object can be achieved. Specifically, since the power is independently supplied to the main control means and the sub-control means from the power source means, respectively, the power is not supplied to the sub-control means with the voltage being lowered due to a voltage drop in the main control means, as the case of supplying the power to the sub-control means via the main control means from the power source means, for example. Thereby, even when a voltage of the power, which is outputted to the main control means and the sub-control means from the power source means, is lowered, it is possible to surely operate the sub-control means and the effect means to which the power is supplied from the sub-control means. In addition, since it is possible to suppress consumption power of each means such as main control means, sub-control means and the like if the voltage is lowered, it is possible to suppress heat generation resulting from the consumption of the power, to prevent an erroneous operation of each means caused by the heat and to reduce a running cost.

Additionally, since it is structured a power supply route of supplying the power to the main control means and the sub-control means from the power source means, respectively, then supplying the power to the symbol display means from the main control means and supplying the power to the effect means from the sub-control means at the same time, it is possible to simplify a wiring or circuit arrangement as compared to a power supply route of supplying the power to all the means from the power source means.

In addition, since the power source means is divided into the main control power source unit and the sub-control power source unit, it is possible to select optimal parts according to each consumption power of the main control means and the sub-control means when designing a circuit of the power source means. Accordingly, it is possible to suppress an increase in costs of the parts of the power source means and to achieve a long life span thereof.

### BRIEF DESCRIPTION OF THE DRAWINGS

Other and further objects, features and advantages of the invention will appear more fully from the following description taken in connection with the accompanying drawings, in which:

FIG. 1 is a schematic view showing an inside of a cabinet of a pachi-slot machine according to an embodiment of the invention;

FIG. 2 is a perspective view of a pachi-slot machine according to an embodiment of the invention;

FIG. 3 is a front view of a liquid crystal display device of a pachi-slot machine according to an embodiment of the invention;

FIG. 4 is a view showing an example of symbols arranged on rotary reels;

FIG. 5 is a perspective view showing a schematic structure of a liquid crystal display device provided to a pachi-slot machine according to an embodiment of the invention;

FIG. 6 is an exploded view of a partial structure of the liquid crystal display device shown in FIG. 5;

FIG. 7 is a schematic view showing a structure of a power source board;

FIG. 8 is a block diagram showing a structure of an electric circuit according to an embodiment of the invention;

FIG. 9 is a block-diagram showing a structure of an electric circuit of a sub-control board shown in FIG. 8;

FIG. 10 is a circuit diagram showing signal lines of the board shown in FIG. 8;

FIG. 11 is a circuit diagram showing each signal line of the board shown in FIG. 8;

FIG. 12 is a circuit diagram showing signal lines of the board shown in FIG. 8;

FIG. 13 is a circuit diagram showing signal lines of the board shown in FIG. 8;

FIG. 14 is a circuit diagram showing signal lines of the board shown in FIG. 8;

FIG. 15A is a circuit diagram showing a structure of a voltage restrictor shown in FIGS. 8 and 9;

FIG. 15B is a circuit diagram showing a structure of a current restrictor;

FIG. 16 is a flow chart of a main routine;

FIG. 17 is a flow chart showing an operation of a sub-control board; and

FIG. 18 is a flow chart of a command processing routine.

### DESCRIPTION OF THE PREFERRED EMBODIMENTS

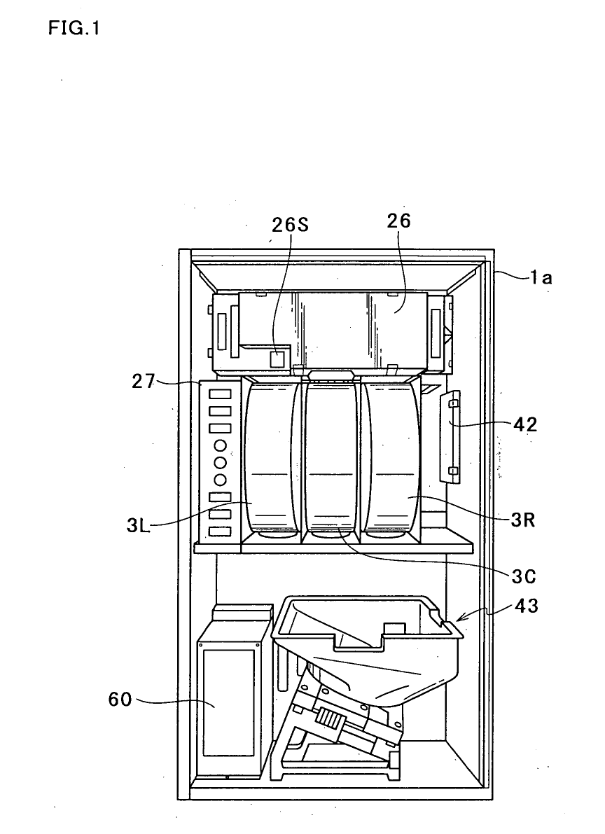

Hereinafter, preferred embodiment of the present invention will be described with reference to FIGS. 1 to 18.

A gaming machine according to an embodiment of the invention is a so-called “pachi-slot machine” and structured in such a way that it can detect an operation of a player to stop a variable display of a plurality of symbols so that a specific winning form is made, based on symbols stopped and displayed on a pay line. In the mean time, the gaming machine is played with a game medium such as coin, medal, gaming ball, and card storing information of a game value which has been awarded or will be awarded to a player. However, in the following descriptions, it will be explained that the gaming machine is played with a medal.

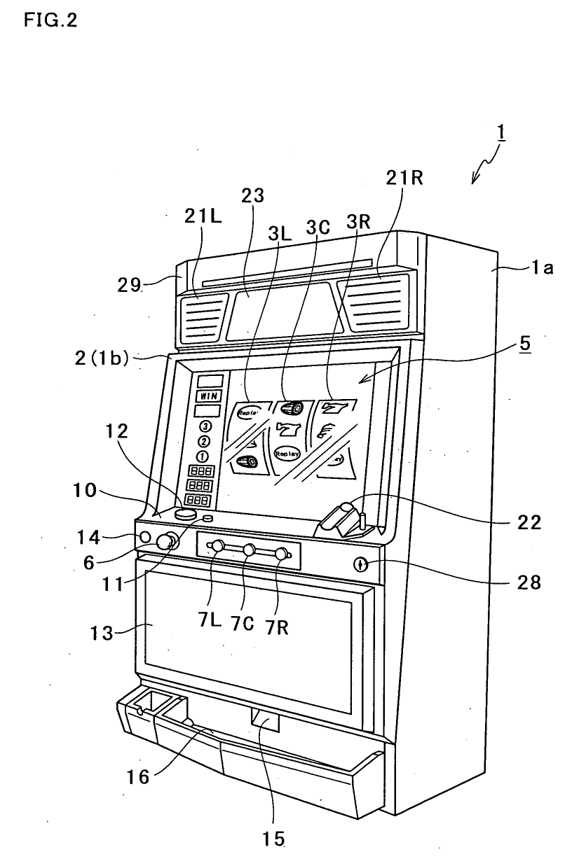

FIG. 2 is an external perspective view of a gaming machine 1. The gaming machine 1 comprises a cabinet 1a and a door frame 1b which is rotatably mounted to the cabinet 1a. Specifically, the cabinet 1a and the door frame 1b are connected with a hinge (not shown) at one side (left in FIG. 2) thereof and the door frame 1b can be opened and closed with respect to the cabinet 1b around the hinge. The door frame 1b is fixed to the cabinet 1a by closing a door opening and closing/use stop-releasing device 28 which will be described later.

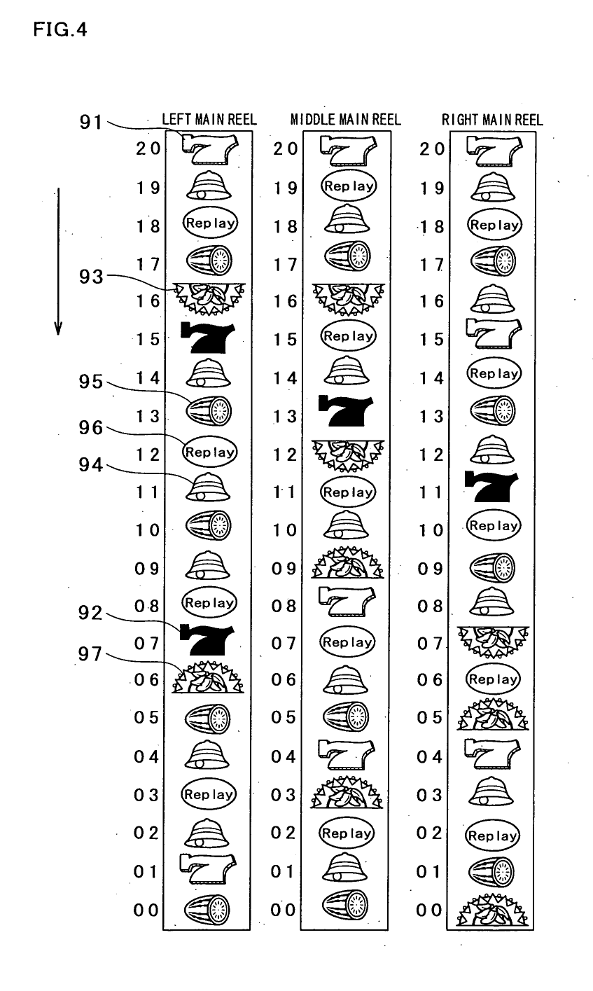

As shown in FIG. 1 schematically showing an inside structure of the cabinet 1a, three rotary reels 3L, 3C, 3R, which are symbol display means, are mounted at an approximately central part of the cabinet 1a in a row. Each of the three rotary reels 3L, 3C, 3R is printed at an outer periphery thereof with a symbol line consisting of plural symbols. The symbol line consists of plural symbols given with code numbers of “00”˜“20”, as shown in FIG. 4. Specifically, the symbol line comprises ^{┌}Red 7 (symbol 91)_{┘}, ^{┌}Blue 7 (symbol 92)_{┘}, Lower Chili pepper (symbol 93)_{┘}, ^{┌}Bell (symbol 94)_{┘}, ^{┌}Watermelon (symbol 95)_{┘} ^{┌}Replay (symbol (96)_{┘}, ^{┌}Upper Chili pepper (symbol 97)_{┘}. Each of the rotary reels is provided with a stepping motor and rotates at a constant speed (for example, 80 revolutions/minute). Among the symbols, the ^{┌}Red 7 (symbol 91)_{┘} and ^{┌}Blue 7 (symbol 92)_{┘} are set to structure a specific winning mode. The specific winning mode is meant by a winning mode in which a bonus such as BB (big bonus) or RB (regular bonus), which will be described later, is made.

Referring to FIG. 1 again, a lamp display unit 27 is mounted at a left side of the rotary reels 3L, 3C, 3R. The lamp display unit 27 is provided with various lamps such as game start display lamp 25, winning display lamp (also referred to as ^{┌}WIN_{┘} lamp) 17, medal insertion lamp 24, 1-BET lamp 9a, 2-BET lamp 9b and MAX-BET lamp 9c and various display units such as payout number display unit 18, credit display unit 19 and single bonus operation (bonus) number display unit 20.

The 1-BET lamp 9a, 2-BET lamp 9b and MAX-BET lamp 9c are turned on according to medal number (hereinafter, also referred to as BET number) bet so as to play a single game (unit game). Meanwhile, a single game is ended when all the rotary reels are stopped, or when the medal is paid out in case that it is performed a payout of the medal.

The WIN lamp 17 is turned on at a predetermined probability in case that an internal winning is made in the BB or RB. In addition, it is also turned on in case that a winning of BB or RB is made. The internal winning is meant by that a winnable combination is drawn by a CPU 31. The medal insertion lamp 24 blinks when it can receive a medal insertion. The game start display lamp 25 is turned on when at least one of pay lines 8a˜8e, which will be described later, is activated.

The payout number display unit 18 displays the payout number of the medal when a winning is made. The credit display unit 19 displays the number of medals stored. The bonus number display unit 20 displays the number of possible RB games and the number of possible RB game winnings. These display units consist of 7 segment indicators.

A control box 26 is mounted above the rotary reels 3I, 3C, 3R. Each of boards controlling the gaming machine 1 is received in the control box 25. Specifically, a main control board 71 (main control means) controlling the whole gaming machine 1, a sub-control board 73 (sub-control means) controlling a liquid crystal display device 5 or LED lamp 29 which are effect means, and the like are received in the control box. Detailed structures of the boards will be described later.

In addition, the control box 26 has a setting key-type switch 26S and is structured in such a way that it can divide a probability of winning modes into several stages (for example, 6 stages) to perform a setting change. The setting key-type switch 26S is such structured that a predetermined key is inserted and turned to make it ON state, thereby causing the setting change to be effective, for example. In addition, the setting key-type switch 26S may become an ON state by inserting and turning the predetermined key, or alternatively, by inserting passwords.

In addition, an external concentration terminal plate 42 is mounted at a right side of the rotary reel 3R, which is an internal side wall of the cabinet 1a. The external concentration terminal plate 42 is connected to the control box 26 (specifically, main control board 71) and a hall computer (not shown). When the external concentration terminal plate receives a state signal of the gaming machine 1, for example a management information signal indicating whether it is under BB or RB game, a medal insertion signal indicating the medal insertion or payout, a medal payout signal and the like from the main control board 71, it transmits the signal to the hall computer. The hall computer is meant by a computer managing a hall (game arcade) in which the gaming machine 1 is equipped and monitors the signal transmitted from the external concentration terminal plate 42 provided in the gaming machine 1 to manage a problem or illegal act in the gaming machine 1.

In addition, a hopper unit 43 which is game value payout means is mounted below the rotary reels 3I, 3C, 3R. The hopper unit 43 is provided with a tank for storing medals therein, a hopper for lining up and paying out medals, a medal sensor for detecting the number of medals to be paid out and the like.

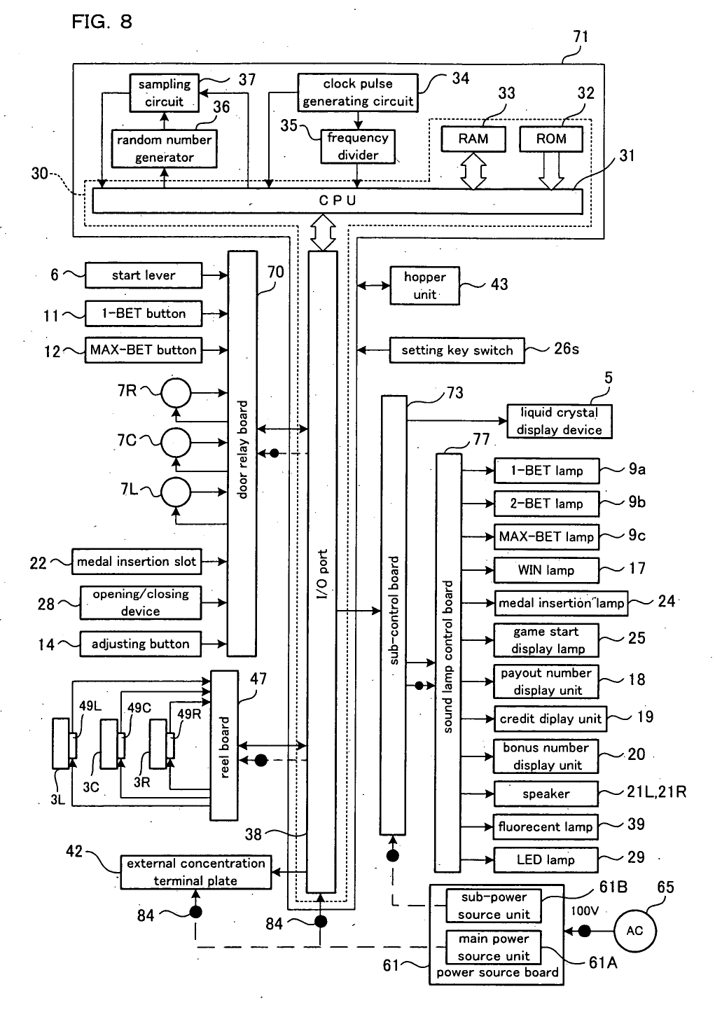

A power source box 60 is mounted at a left side of the hopper unit 43. The power source box 60 comprises a power source board 61 (see FIG. 8) therein which is power source means, is connected to a power source 65 (see FIG. 8) of AC 100V and supplies a voltage of DC 12V to the control box 26 (specifically, main control board 71 and sub-control board 73) and the external concentration terminal plate 42 in parallel, respectively. For example, in case that the power is supplied to the sub-control board 73 or external concentration terminal plate 42 via the main control means 71 from the power source board 61, the power is supplied to the sub-control board 73 or the external concentration terminal plate 42 with the voltage being lowered due to a voltage drop in the main control means 71. However, as described above, since the power is respectively supplied to the main control board 71, the sub-control board 73 and the external concentration terminal plate 42 from the power source board 61, even when a voltage of the power from the power source board 61 is lowered, it is possible to surely operate the liquid crystal display device 5, the LED lamp 29 and the external concentration terminal plate 42 which are controlled by the sub-control board 73.

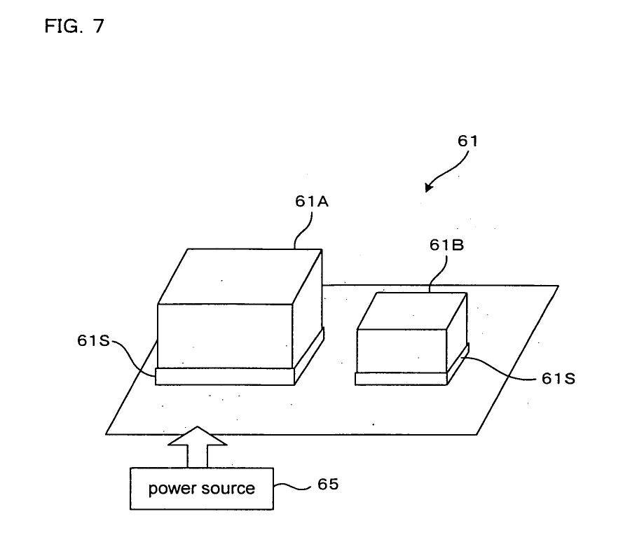

In addition, as shown in FIG. 7, the power source board 71 comprises a main control board power source unit 61A (hereinafter, referred to as main power source unit) supplying the power to the main control board 71 and a sub-control board power source unit 61B (hereinafter, referred to as sub-power source unit) supplying the power to the sub-control board 73, and the main control board 71 and the sub-control board 73 are respectively supplied with the power from the different power source units.

The main power source unit 61A (main control power source unit) and the sub-power source unit 61B (sub-control power source unit) comprise a block-type circuit required to supply the power and is detachably connected to the power source board 61. For example, sockets 61S are provided to the power source board 61 and the main power source unit 61A and the sub-power source unit 61B are connected to the sockets, so that the main power source unit 61A and the sub-power source unit 61B can be easily mounted. Since the power source board 61 is divided into the main power source unit 61A and the sub-power source unit 61B, it is possible to select optimal parts according to each consumption power of the main power source unit 61A and the sub-power source unit 61B when designing a circuit of the power source board 61. Accordingly, it is possible to suppress an increase in costs of the parts of the power source means and to achieve a long life span thereof. In addition, since the attachment can be easily performed, even when it is desired to change the consumption power of anyone, the change operation can be simply performed.

In addition, it is such structured that the main power source unit 61A the sub-power source unit 61B can be discriminated from each other. For example, the main power source unit 61A may be colored with a blue color and the sub-power source unit 61B may be colored with a red color, so that it is possible to eliminate an erroneous replacement and to reduce operation mistakes.

Referring back to FIG. 2, the door frame 1b of the gaming machine 1 comprises a cabinet 2. The liquid crystal display device 5 is provided at a front side of the cabinet 2. The liquid crystal display device 5 is arranged to be positioned on a front part of the three rotary reels 3L, 3C, 3R and structured such that the plural symbols printed on the rotary reels 3I, 3C, 3R can be discriminated with naked eyes, thereby displaying effects by a character and the like. In addition, the various lamps or display units of the lamp display unit 27 (for example, game start display lamp 25, etc.) can be also discriminated with naked eyes through the liquid crystal display device 5 at the front of the cabinet 2, likewise the rotary reels 3L, 3C, 3R. In the mean time, in this embodiment, although it is described that the liquid crystal display device 5 is provide at the front side of the rotary reels 3L, 3C, 3R, it should be noted that the invention is not limited to the position of the liquid crystal display device 5. In addition, the liquid crystal device display 5 will be specifically described later.

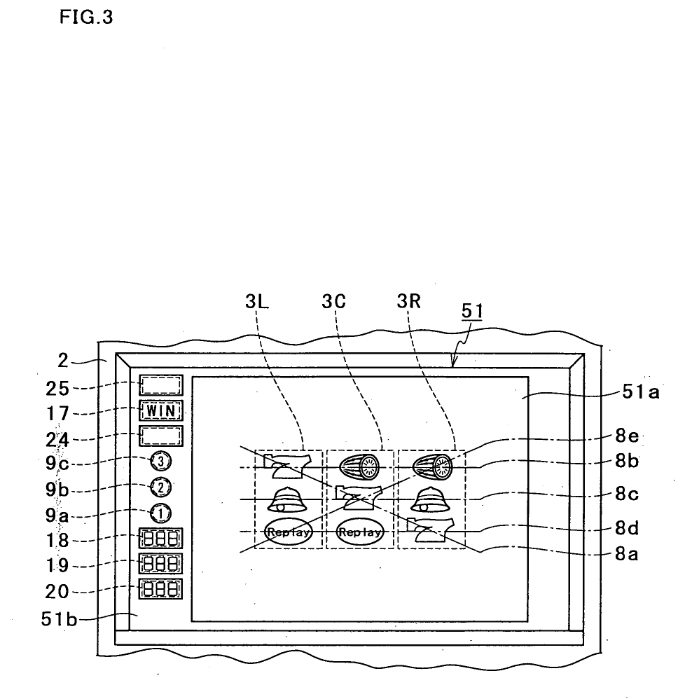

As shown in FIG. 3, it is structured that the symbols of the rotary reels 3L, 3C, 3R can be discriminated through the liquid crystal display device 5 at the front of the cabinet 2. Specifically, by 3 symbols in a longitudinal direction, i.e., a total of 9 symbols of the rotary reels 3L, 3C, 3R can be discriminated with naked eyes. In addition, it is set five pay lines corresponding to stationary positions of the nine symbols which can be discriminated with naked eyes. Specifically, it is structured a top line 8b, a center line 8c and a bottom line 8d which horizontally cross the symbols arranged in rows by three in a vertical direction and a cross down line 8a and a cross up line 8e which diagonally cross the symbols.

The pay lines are activated by operating the 1-BET button 11 and the MAX-BET button 12 or inserting a medal into a medal insertion slot 22. Specifically, when one is bet, one pay line (only the center line 8c) is activated, when two are bet (the 1-BET button 11 is operated (pushed) two times or the two medals are inserted), the three pay lines (the top line 8b and the bottom line 8d in addition to the center line 8c) are activated and when the maximum is bet (three in the embodiment), the five pay lines (the cross down line 8a and the cross up line 83 in addition to the three lines when two are bet) are activated. The pay lines 8a to 8e are related to whether the winning of a combination is realized or not. Specifically, if the symbols constituting a symbol combination corresponding to a predetermined combination are arranged and stopped at a predetermined position corresponding to any one activated pay line, a winning of the predetermined combination is realized. In the following descriptions, the activated pay line may be also referred to as an activated line.

A base portion 10 having a horizontal surface is provided to a lower part of the liquid crystal display device 5. The medal insertion slot 22 is formed at a right side of the base portion 10 and the 1-BET button 11 and the MAX-BET button 12 are provided at a left side of the base portion 10. The 1-BET button 11 is adapted to bet one of the credited medals on one game through a single push operation and to bet two of the credited medals on one game through two push operations. The MAX-BET button 12 is adapted to bet the maximum number (three in this embodiment) capable of being bet on one game. The pay lines 8a to 8e are adapted to be activated by operating the BET buttons 11, 12.

A deposit-medal adjusting button 14 (hereinafter, referred to as adjusting button) changing credits/payouts of the medals, which are obtained by a player through the game, through a push operation is provided at a frontal left side of the base portion 10. In case that the “payout” is selected by the change of the adjusting button 14, the medals are paid out from a payout slot 15 at a frontal lower side and the paid out medals are collected in a medal receiving tray 16. In the mean time, in case that the “credit” is selected, the medal number is deposited in a memory provided in the gaming machine 1 (for example, RAM 33 which will be described later) in a credit form. At a right side of the adjusting button 14, it is provided with a start lever 6 for rotating the rotary reels 3I, 3C, 3R by the operation of the player and starting a game. The start lever 6 is mounted to be rotatable within a predetermined range of angles so that the player can push it with a finger and the like.

Three stop buttons 7L, 7C, 7R for stopping the rotations of the three rotary reels 3L, 3C, 3R are equipped at a frontal center of the base portion 10. The stop buttons 7L, 7C, 7R have LEDs (not shown) and are turned on after the rotations of the rotary reels 3L, 3C, 3R and turned off after the operation. Thereby, it is possible to notify the player that the stop buttons 7L. 7C. 7R can be operated.

In addition, the BET buttons 11, 12, the adjusting button 14 and the like may be provided with a LED, likewise the stop buttons 7L. 7C. 7R. In this case, the LED may be turned on or blinked to notify the player that the button can be operated (pushed).

The door opening and closing/stop-releasing device 28 (hereinafter, it will be referred to as opening/closing device) is equipped at a frontal right side of the base portion 10. The opening/closing device 28 stops the game by turning it in a right direction with a predetermined key to release a locked state of the door frame 1b, and is locked by turning it in a left direction. In addition, the opening/closing device 28 performs a stop-release at the same time with the locking. Herein, the “stop” is meant by a state at which a game cannot be played (stop state).

Speakers 21L, 21R are equipped at upper right and left sides of the cabinet 2 and a payout table panel 23 is provided between the two speakers 21L, 21R, which displays combinations of the winning symbols, payout number of the medals and the like. In addition, a LED lamp 29 is equipped above the speakers 21L, 21R or the payout table panel 23 and adapted to be blinked according to effects resulting from the game states. A display panel 13 is equipped at a lower side of the cabinet 2 and printed with characters and the like, for example. A fluorescent lamp 39 (see FIG. 8) is provided in the display panel 13. By turning on the fluorescent lamp 13, the symbol such as printed characters and the like is remarkably conspicuous and thus attracts a player's attention, who is choosing the gaming machine 1 to be played.

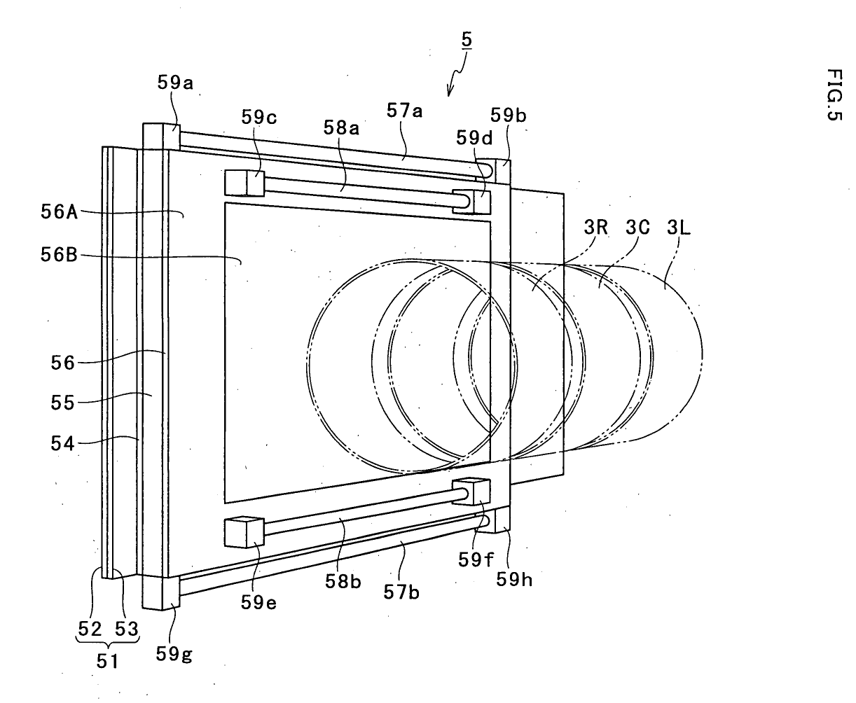

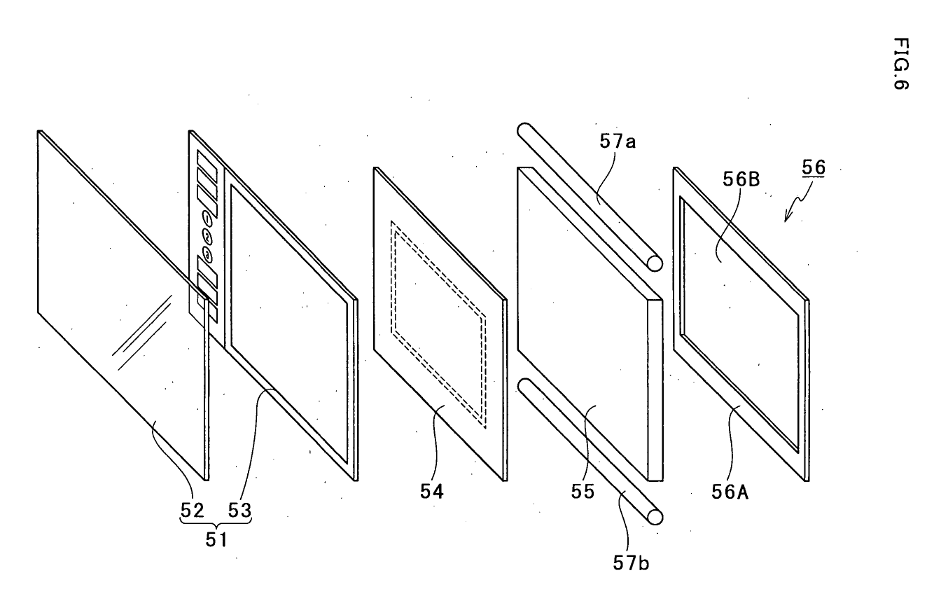

Next, the liquid crystal display device 5 is specifically described. As shown in FIGS. 5 and 6, the liquid crystal display device 5 comprises a front panel 51 consisting of a protecting glass 52 and a display plate 53, a transmissive liquid crystal panel 54, a light guide plate 55, a reflecting film 56, fluorescent lamps 57a, 57b, 58a, 58b which are so-called white light sources, lamp holders 59a to 59h and a table carrier package (TCP) having an IC for driving the transmissive liquid crystal panel 54 mounted thereto. The TCP consists of a flexible board (not shown) connected to a terminal unit of the transmissive liquid crystal panel 54, and so on. The liquid crystal display device 5 is equipped in front of the rotary reels 3L, 3C, 3R (i.e., a side facing the player), as described above. In addition, the rotary reels 3L, 3C, 3R and the liquid crystal display device 5 are mounted at a predetermined interval therebetween.

The protecting glass 52 and the display plate 53 consist of transmissive members. The display plate 53 is formed with symbols and the like at positions corresponding to the BET lamps 9a to 9c and the like. In other words, an area in which the symbols and the like of the display plate 53 are formed is a symbol forming area 51b of the front panel 51 and an area in which the symbols and the like of the display plate 53 are not formed is a display window 51a of the front panel 51. Alternatively, a front face of the front panel 51 may be the display window 51a without forming the symbol forming area 51b at the front panel 51. In this case, the symbol may be not formed on the display plate 53 or the display plate 53 may be omitted. In addition, it is not shown an electric circuit for driving the various lamps and the various display units positioned on a rear side of the display plate 53.

In the transmissive liquid crystal panel 54, liquid crystals are sealingly injected in a gap between a transmissive board such as glass plate having a thin film transistor layer formed thereon and a transmissive board opposite to the board. A display mode of the transmissive liquid crystal panel 54 is set with a normally white. The normally white is such a structure that it becomes a white display under state that the liquid crystal is not driven (it is possible to discriminate the light transmitted at the display surface with naked eyes from the exterior). By adopting the transmissive liquid crystal panel 54 structured with the normally white, even when there occurs a state at which the liquid crystal cannot be driven, it is possible to discriminate the variably displaying and stopping of the discrimination information such as symbols displayed on the rotary reels 3L, 3C, 3R with naked eyes, so that the game can be continuously played. In other words, even when there occurs such state, it is possible to play the game in relation to the variably displaying and stopping modes of the discrimination information displayed on the rotary reels 3L, 3C, 3R.

The light guide plate 55 is provided to guide the light from the fluorescent lamps 57a, 57b into the transmissive liquid crystal panel 54 (to illuminate the transmissive liquid crystal panel 54) and equipped at the rear side of the transmissive liquid crystal panel 54 and consists of a transmissive member (having a light guide function) such as acryl-based resin having about 2 mm thickness, for example.

For the reflecting film 56, it is possible to use a material having silver deposition film formed on a white polyester film or aluminum thin film, for example. The reflecting film reflects the light, which is introduced into the light guide plate 55, to the front of the light guide plate 55. The reflecting film 56 consists of a reflecting area 56A and a non-reflecting area (transmissive area) 56B.

The fluorescent lamps 57a, 57b are arranged along upper and lower ends of the light guide plate 55 and supported at their both ends by the lamp holder 59. The light irradiated from the fluorescent lamps 57a, 57b is reflected at the reflecting area 56A to illuminate the transmissive liquid crystal panel 54.

The fluorescent lamps 58a, 58b are arranged at upper and lower parts of the rear side of the reflecting film 56 toward the rotary reels 3L, 3C, 3R. The light, which is emitted from the fluorescent lamps 58a, 58b, reflected at the surfaces of the rotary reels 3L, 3C, 3R and incident on the non-reflecting area 56B, illuminates the transmissive liquid crystal panel 54.

Like this, in the liquid crystal display device 5, the light which is irradiated from the fluorescent lamps 57a, 57b and reflected to the reflecting area 56A of the reflecting film 56 and the light which is irradiated from the fluorescent lamps 58a, 58b, reflected at the surfaces of the rotary reels 3L, 3C, 3R and incident on the non-reflecting area 56B illuminate the transmissive liquid crystal panel 54. Accordingly, an area of the liquid crystal display device 5 corresponding to the non-reflecting area 56B of the reflecting film 56 is an area that is changed into transmissive/non-transmissive states according to whether the liquid crystal is driven or not, and an area of the liquid crystal display device corresponding to the reflecting area 56A of the reflecting film 56 becomes the non-transmissive state irrespective of whether the liquid crystal is driven or not.

Although only partial area of the liquid crystal display device 5 is the area that is changed into the transmissive/non-transmissive states in the gaming machine 1, a display screen of the liquid crystal display device becomes entirely the area that is changed into the transmissive/non-transmissive states in the gaming machine of the invention. In this case, when the whole area of the liquid crystal display device 5 is made to be the area that is changed into the transmissive or non-transmissive state in the gaming machine 1, the reflecting film 56 may be made of the non-reflecting area 56B or the reflecting film 56 may be omitted.

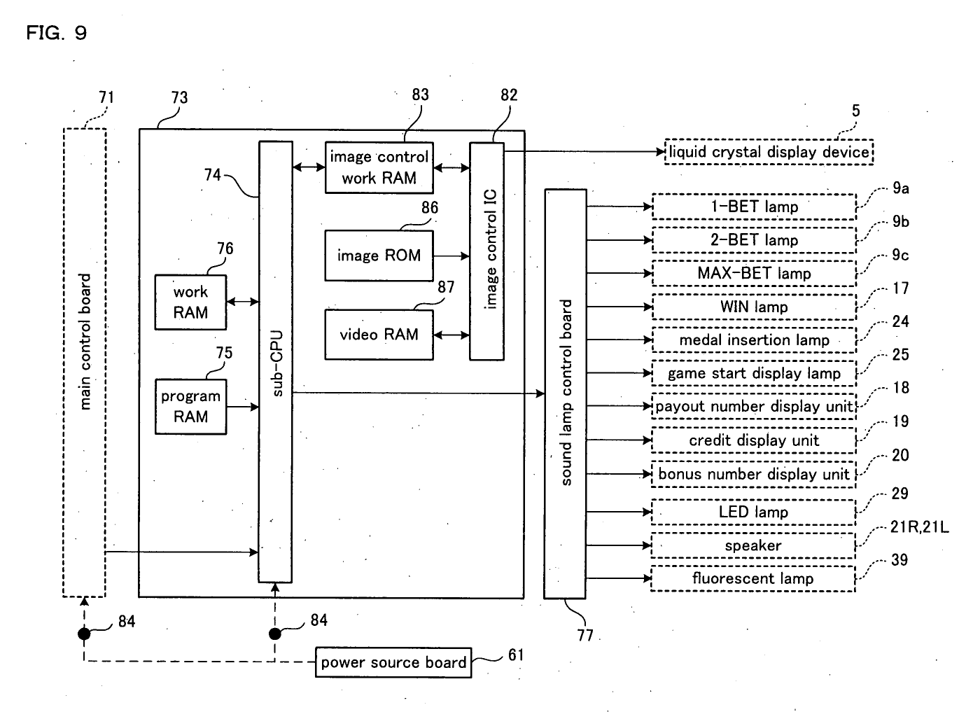

Next, an electrical structure of the gaming machine 1 will be described with reference to FIGS. 8 to 15. In addition, in FIGS. 8 and 9, a solid line arrow indicates an electric signal line and a dotted line arrow indicates a power supply line.

(Main Control Board)

The main control board 71 is a main board controlling the whole game of the gaming machine 1 and received in the control box 26. The main control board 71 comprises a micro computer 30 arranged on the board as an essential constituting element and is further provided with a circuit for sampling random numbers. The micro-computer 30 includes the CPU 31 performing a control operation according to preset programs and a ROM 32 and a RAM 33 which are storing means.

To the CPU 31 is connected a clock pulse generating circuit 34 for generating a reference clock pulse, a frequency divider 35, a random number generator 36 for generating random numbers to be sampled and a sampling circuit 37. The random number generator 36 generates random numbers within a predetermined numerical range. The sampling circuit 37 samples one random number at an appropriate timing after the start lever 6 is operated. The CPU 31 is adapted to determine a winning combination, based on the random numbers sampled through the random number generator 36 and the sampling circuit 37 and a probability sortition table stored in the ROM 32. The winning combination is adapted to contain the winning information of the bonuses (BB, RB) which have been drawn before a previous game and are not yet won. For example, in case that “BB” is determined to be a winning combination in a previous game of a specific game according to the process based the probability sortition table and the “BB” is not won and “Replay” is determined to be a winning combination in the specific game according to the process based on the probability sortition table, the “BB”, which is the winning combination in the previous game, and the “Replay” become a winning combination in the specific game.

In the mean time, as the means for sampling the random number, the random number sampling may be performed in the micro computer 30, i.e., through an operating program of the CPU 31. In this case, the random number generator 36 and the sampling circuit 37 may be omitted or kept for a backup of the random number sampling operation.

In addition, various information is temporarily stored in the RAM 33 of the main control board 71. For example, a gaming state which is being played or the number of medals inserted is stored. In the mean time, various data tables such as the probability sortition table used to determine the random number sampling performed whenever the start lever 6 is operated (start operation) and a stop table group for determining the stopping modes of the reels according to the operations of the stop button and various control commands for being transmitted to the sub-control board 73 are stored in the ROM 32 of the main control board 71. In addition, a program for executing a process routine which will be described later and the like is stored in the ROM 32.

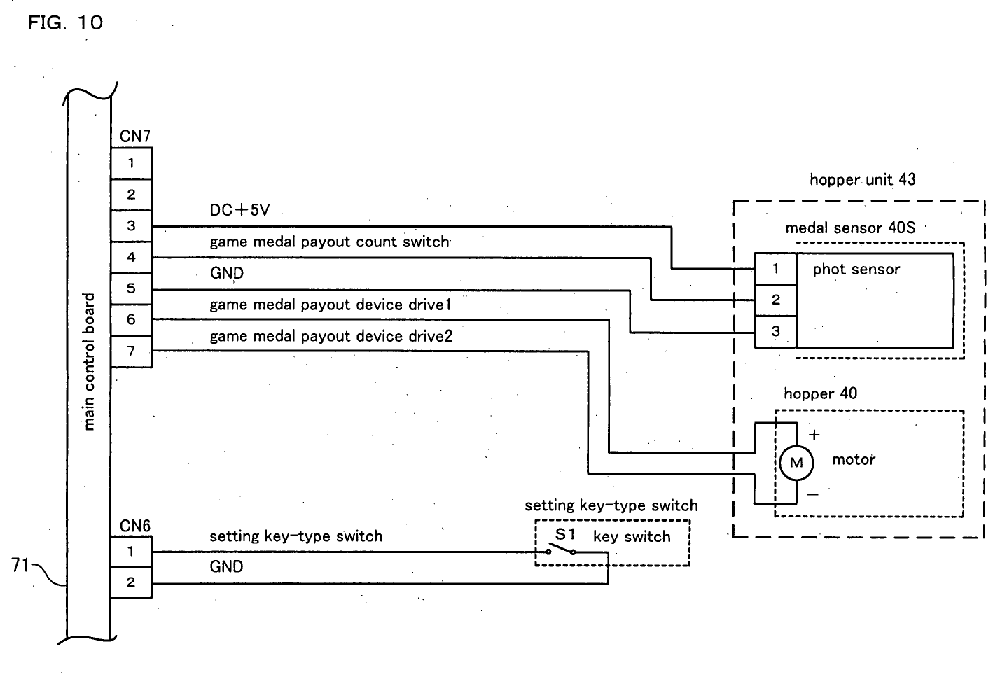

In addition, the hopper unit 43 and the setting key switch 26S are connected to the main control board 71. Specifically, as shown in FIG. 10, the hopper unit 43 receives the medals and comprises a hopper 40 for paying out a predetermined number of medals according to the winning combination and a medal sensor 40S for counting the medals paid out. The hopper 40 is connected to the main control board 71 through a control signal line controlling a motor and the medal sensor 40S is connected to the main control board 71 through a wiring consisting of a voltage line of DC 5V and a signal line transmitting a count signal. In addition, the medal sensor 40S transmits a signal whenever it detects a medal paid out and counts the medal number whenever a signal is received in the main control board 71.

In addition, the setting key-type switch 26 has a key switch S1. In a normal state, the switch is under opened state (OFF), so that the setting key switch is isolated from the connection with the main control board 71. Accordingly, even though the setting is changed, a signal is not transmitted to the main control board 71. When the setting key-type switch 26 is normally operated (for example, its locked state is released with a predetermined key), the key switch S1 is under closed state (OFF) and a setting change value is transmitted to the main control board 71, so that the setting change becomes effective.

(Door Relay Board)

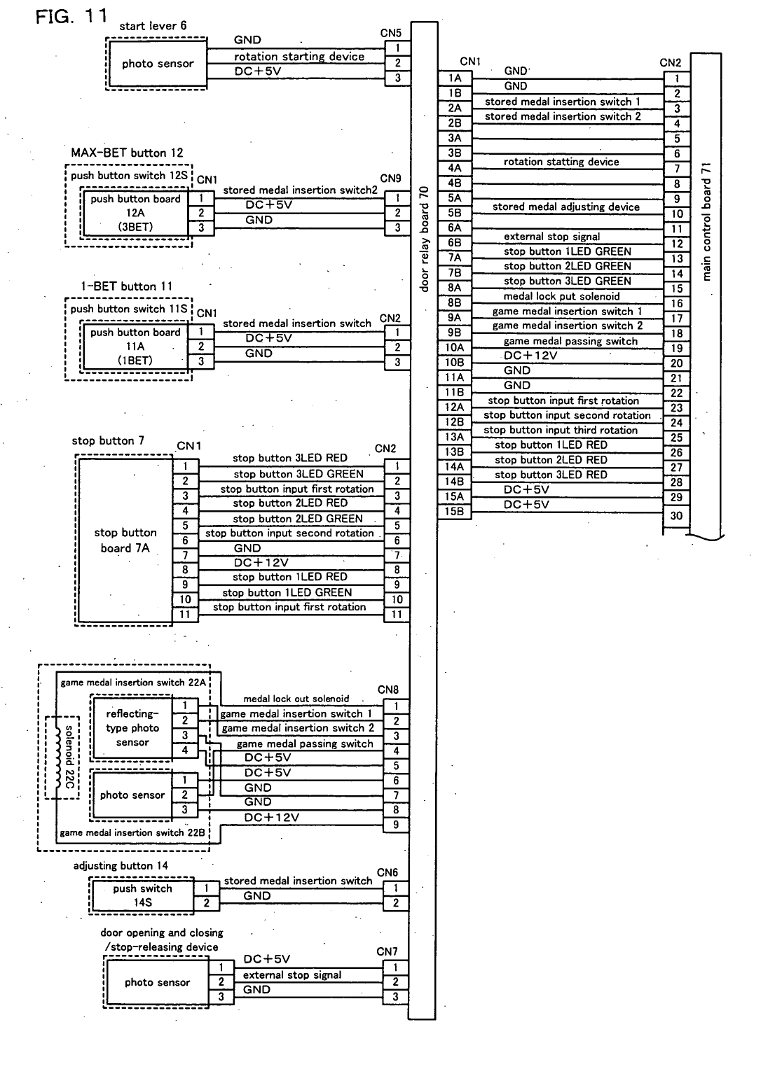

As shown in FIG. 11, the main control board 71 is connected to a door relay board 70 through a wiring consisting of plural voltage lines and plural signal lines. The door relay board 70 is supplied with voltage of DC 12V or DC 5V from the main control board 71 through the voltage lines and supplies the power to the BET buttons connected to the door relay board 70 through the signal lines, which buttons will be described later. In addition, the door relay board 70 transmits a signal from the BET buttons connected to the door relay board 70 to the main control board 71 or receives a control signal which is transmitted to each BET button from the main control board 71, through the signal lines.

The start lever 6 is connected to the door relay board 70. Specifically, the start lever 6 is provided with a photo sensor 6S detecting an operation of the start lever 6. The photo sensor 6S is connected to the door relay board 70 through a wiring consisting of a voltage line of DC 5V and a signal line transmitting a detection signal. When the start lever 6 is operated, a game start command signal is transmitted from the door relay board 70 to the main control board 71.

In addition, the MAX-BET button 12 is connected to the door relay board 70. Specifically, the MAX-BET button 12 is connected to a push button board 12A and provided with a push button switch 12S detecting an operation of the MAX-BET button 12. The push button board 12A is connected to the door relay board 70 through a wiring consisting of a voltage line of DC 5V and a signal line transmitting a detection signal. When the MAX-BET button 12 is pushed, a stored medal insertion command signal for inserting a medal is transmitted from the door relay board 70 to the main control board 71. In addition, since the 1-BET button 11 has the same structure as the MAX-BET button 12, its description is omitted.

The stop buttons 7L, 7C. 7R are connected to the door relay board 70. Specifically, the stop buttons 7L, 7C, 7R are controlled by a push button board 7A connected thereto. The push button board 7A is connected to the door relay board 70 through a wiring consisting of a voltage line of DC 12V and a signal line. The signal line is one to which a control signal controlling the LEDs provided to the stop buttons 7L, 7C, 7R and a stop signal allowing the rotary reels 3L, 3C, 3R to be stopped when the stop buttons 7L, 7C, 7R are pushed are transmitted and supplied. When the stop buttons 7L, 7C, 7R are pushed, a command signal for stopping the rotary reels is transmitted from the door relay board 70 to the main control board 71.

Further, the medal insertion slot 22 is connected to the door relay board 70. Specifically, the medal insertion slot 22 is provided with a game medal insertion switch 22A, a game medal passing switch 22B and a solenoid 22C, each of which is connected to the door relay board 70. More specifically, the game medal insertion switch 22A is provided with a reflecting-type photo sensor detecting medal insertion, and the reflecting-type photo sensor is connected by a wiring consisting of a voltage line of DC 5V and a signal line transmitting a detection signal. The game medal passing switch 22B is provided with a photo sensor detecting whether the inserted medal have passed through the insertion slot or not, and the photo sensor is connected by a wiring consisting of a voltage line of DC 5V and a signal line transmitting a detection signal. Further, the solenoid 22C is connected to the door relay board 70 through a voltage line of DC 12V. In addition, when the solenoid 22C is supplied with DC 12V, it closes the medal insertion slot 22 with a metal member by magnetic force so that a medal cannot be inserted.

In addition, the adjusting button 14 is connected to the door relay board 70. Specifically, the adjusting button 14 is provided with a push switch 14S which outputs a H signal or L signal whenever there occurs a push operation. The push switch 14S is connected to the door relay board 70 by a signal line transmitting the L signal or H signal. When the adjusting button 14 is pushed, it transmits the L signal or H signal to the door relay board 70. In other words, the adjusting button transmits a change signal for paying out the obtained medal or changing the storing (credit). In addition, in this case, it may be such structured that the medal is paid out when the L signal is transmitted or when the H signal is transmitted.

The opening/closing device 28 is connected to the door relay board 70. Specifically, the opening/closing device 28 is provided with a photo sensor 28S detecting an operation of the opening/closing device 28. The photo sensor 28S is connected to the door relay board 70 by a wiring consisting of a voltage line of DC 5V and a signal line transmitting a detection signal. When the opening/closing device 28 is released from its locked state by a predetermined key, a stop signal for stopping the game is transmitted from the door relay board 70 to the main control board 71. When a locking operation is made, the stop signal is not transmitted, so that the stop is released.

(Reel Board)

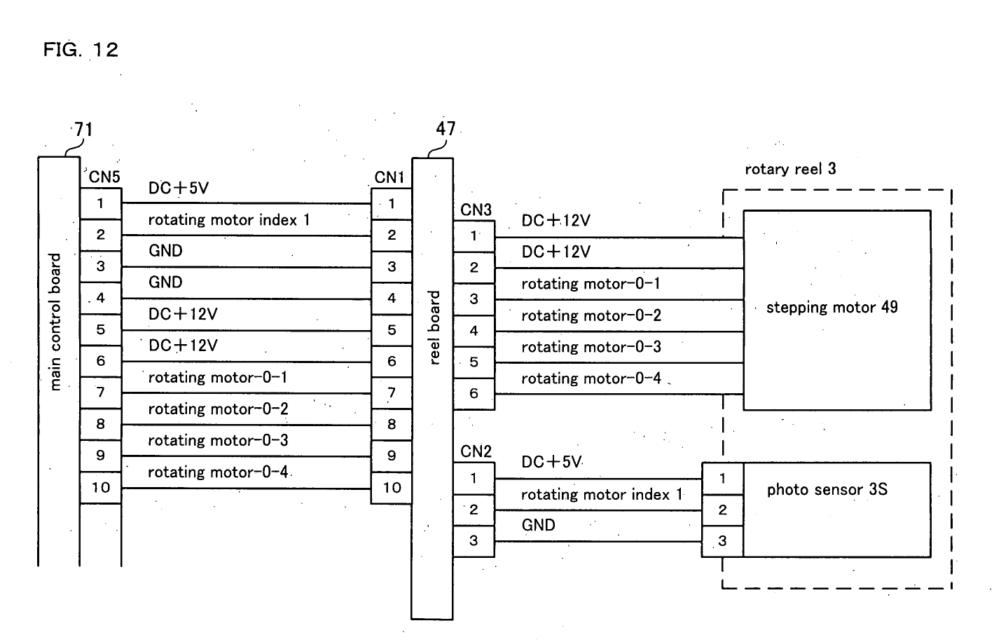

As shown in FIG. 12, the main control board 71 is connected to a reel board 47 by a wiring consisting of plural voltage lines and plural signal lines. The reel board 47 is supplied with a voltage of DC 12V or DC 5V from the main control board 71 through the voltage lines and supplies the power to a stepping motor 49 and the like connected to the reel board 47. In addition, the reel board 47 receives a control signal controlling the stepping motor and transmits a detection signal from a photo sensor 3S, through the signal lines.

A rotary reel 3 is connected to the reel board 47. Specifically, the rotary reel 3 is provided with the stepping motor 49 rotating the rotary reel 3 and the photo sensor 3S detecting a position of the rotary reel 3, each of which is connected to the reel board 47 through a wiring consisting of a voltage line and a signal line. When the start lever 6 is operated and the game start command signal is transmitted to the main control board 71, the stepping motor 49 receives a motor driving signal for driving the stepping motor 49 from the main control board 71 through the reel board 47. In addition, when the stop button 7 is pushed and thus the command signal for stopping the rotary reel is transmitted to the main control board 71, the stepping motor receives a motor stop signal for stopping the stepping motor 49. When the stepping motor 49 is stopped, the photo sensor 3S detects a stop position of the rotary reel 3 and transmits a position detection signal. In addition, although one rotary reel is shown in FIG. 12, the gaming machine 1 is provided with the three rotary reels 3L, 3C, 3R, as described above.

(External Concentration Terminal Plate)

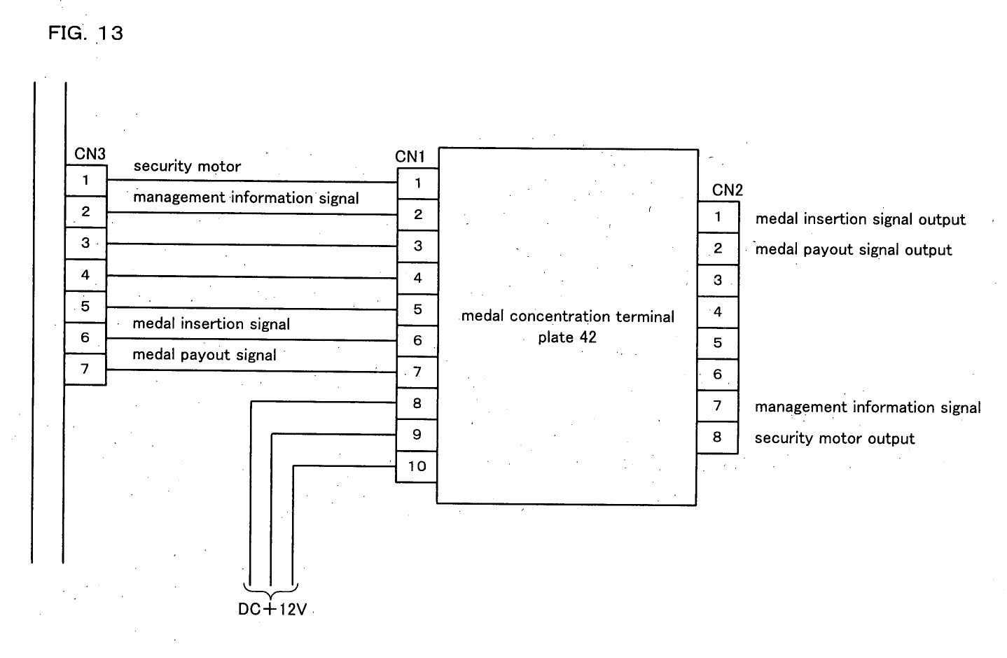

The main control board 71 is also connected to the external concentration terminal plate 42. As described above, when the external concentration terminal plate 42 is supplied with a game information signal (for example, medal payout signal or medal insertion signal) from the main control board 71, it transmits the received signal to the hall computer (not shown). Specifically, as shown in FIG. 13, the external concentration terminal plate 42 is connected to the main control board 71 by a plurality of signal lines and supplied with the power through a voltage line of DC 12V. In addition, the external concentration terminal plate 42 is provided with a relay (not shown) and the information signal transmitted from the main control board 71 is transmitted to the hall computer through the relay. The relay is provided with a contact unit for opening and closing it. In case that the external concentration terminal plate 42 is not supplied with the power, the contact unit is under opened state and when the power is supplied, the contact unit is under closed state. Accordingly, it is such structured that the information signal from the main control board 71 can be transmitted to the hall computer when the external concentration terminal plate is supplied with the power.

(Sub-Control Board)

In addition, the main control board 71 is connected to the sub-control board 73 so that it can output a command or information in one direction. As shown in FIG. 9, the sub-control board 73 comprises a micro computer (hereinafter, referred to as “sub-micro computer”) including a sub-CPU 74 carrying out a control operation according to the control command transmitted from the main control board 71, a program ROM 75 which is storing means of the sub-board and a work RAM 76 as essential constituting elements and is provided with an image control circuit which is display control means of the liquid crystal display device 5. The image control circuit is provided with an image control IC 82, an image control work RAM 83, an image ROM 86 and a video RAM 87. The image control IC 82 displays an image on the liquid crystal display device 5 according to an image control program, based on display parameters set in the sub-micro computer. The image control work RAM 83 is constituted as temporary storing means (buffer) when the image control program is executed in the image control IC 82. The image ROM 86 stores dot data for forming an image (character image or background image). The video RAM 87 is constituted as temporary-storing means when an image is formed in the image control IC 82.

In the mean time, although the sub-control board 73 is not provided with a clock pulse generating circuit, a frequency divider, a random number generator and a sampling circuit, it is structured in such a way that it carries out a random number sampling on an operating program of the sub-CPU 74. The sub-CPU 74 determines image effect data and the like to be displayed on the liquid crystal display device 5 according to a signal from the main control board 71. The program ROM 75 stores a control program such as process routine carried out in the sub-CPU 74. In addition, the program ROM 75 stores each table which is referenced when the control program is executed. In addition, the work RAM 76 is constituted as temporary storing means when the control program is executed in the sub-CPU 74.

In addition, the sub-control board 73 is connected to a sound lamp control board 77. The sound lamp control board 77 is provided with a sound source IC controlling sound outputted from the speakers 21L, 21R, a power AMP which is an amplifier, and a lamp driving circuit for driving the LED lamp 29 or fluorescent lamp 39 and performs an output control of the sound from the speakers 21L, 21R and an output control of the LED lamp 29 or fluorescent lamp 39. Further, the sound lamp control board 77 is provided with circuits for driving the BET lamps 9a to 9c, the WIN lamp 17, the medal insertion lamp 24, the game start display lamp 25, the payout number display unit 18, the credit display unit 19 and the bonus number display unit 20 based on the control signal from the main control board 71.

(Power Source Board)

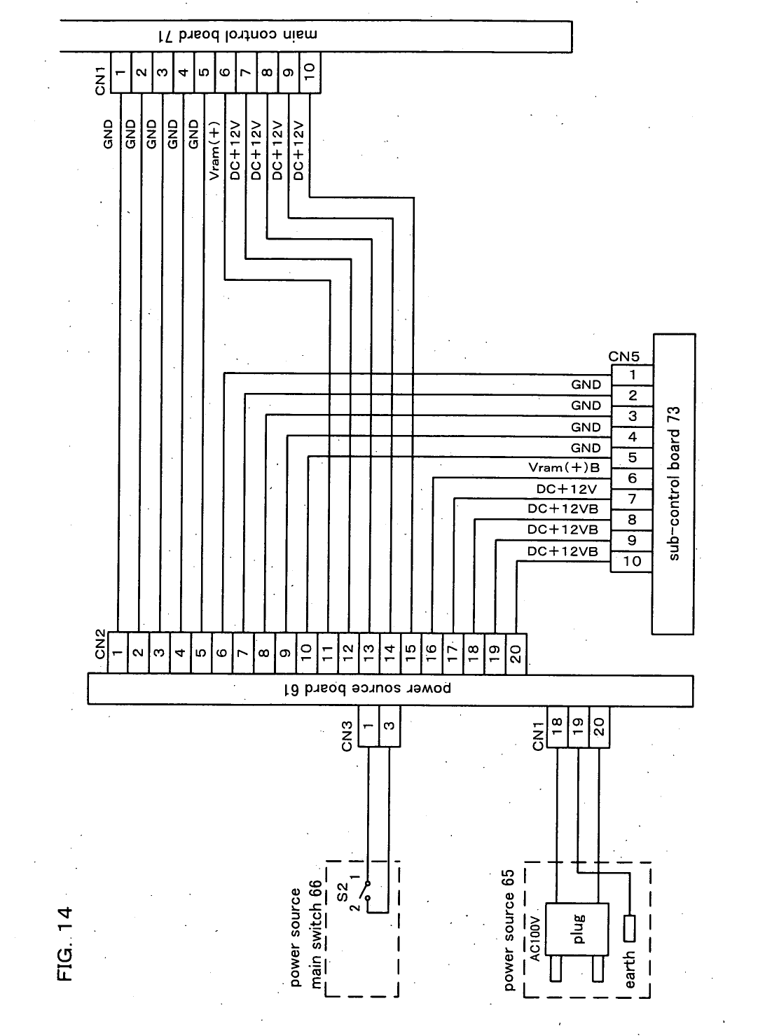

The main control board 71, the sub-control board 73 and the external concentration terminal plate 42 are connected to the power source board 61 received in the power source box 60 and adapted to operate when the power is supplied from the power source board 61. Specifically, the power source board 61 is connected to the main control board 71 and the sub-control board 73 through a wiring consisting of a voltage line of DC 12V and a voltage line supplying a voltage (Vram) for the RAMs 33, 76 of the main control board 71 and the sub-control board 73. In addition, the voltage line supplying the voltage (Vram) may be provided so that contents stored in the RAMs 33, 76 are not erased. In addition, although it is not shown in FIG. 14, the power source board 61 is further connected to the external concentration terminal plate 42 through the voltage line of DC 12V.

As shown in FIG. 14, the power source board 61 is connected to the power source 65 and supplied with a voltage of AC 100V. The power source board 61 supplies the voltage of DC 12V to the main control board 71, the sub-control board 73 and the external concentration terminal plate 42 which are connected thereto. Specifically, the power source board 61 is provided with the main power source unit 61A and the sub-power source unit 61B. The main power source unit 61A supplies the power to the main control board 71 and the external concentration terminal plate 42 and the sub-power source unit 61B supplies the power to the sub-control board 73. In addition, the power source board 61 is connected to a power source main switch 66. An operation of the power source board 61 can be stopped by turning off the power source switch 66. In addition, as described above, the door relay board 70 and the reel board 47 are connected to the main control board 71 through the voltage lines and supplied with the voltage from the main control board 71. Additionally, although the main control board 71 and the sub-control board 73 are connected to the terminals of the power source board 61 in FIG. 14, the connection terminals may be separately provided. In this case, the wiring is simplified.

Like this, since the power is respectively supplied to the main control board 71, the sub-control board 73 and the external concentration terminal plate 42 from the power source board 61, the voltage is not supplied to the sub-control board 73 or the external concentration terminal plate 73 with a voltage being lowered due to a voltage drop in the main control board 71, as the case of supplying the power to the sub-control board 73 or the external concentration terminal plate 42 via the main control board 71 from the power source board 61, for example. Thereby, even when a voltage of the power, which is outputted to the main control board 71 and the sub-control board 73 from the power source board 61, is lowered from 24V, which is a general voltage, to 12V, it is possible to surely operate the sub-control board 73 and the liquid crystal display device 5 to which the power is supplied from the sub-control board 73. In addition, since it is possible to suppress consumption power of the main control board 71 or the sub-control board 73 if the voltage is lowered, it is possible to suppress heat generation resulting from the consumption of the power, to prevent an erroneous operation of each board caused by the heat and to reduce a running cost. In addition, it is possible to prevent a problem in that false data is transmitted to the hall computer through the external concentration terminal plate to cause a trouble in management.

Further, since it is structured a power supply route of supplying the power to the main control board 71 and the sub-control board 73 from the power source board 61, respectively, then supplying the power to the symbol display means from the main control board 71 and supplying the power to the effect means from the sub-control board 73 at the same time, it is possible to simplify a wiring or circuit arrangement as compared to a power supply route of supplying the power to all the means from the power source board 61.

In addition, since the power source board 61 is divided into the main control power source unit 61A and the sub-control power source unit 61B, it is possible to select optimal parts according to each consumption power of the main control board 71 and the sub-control board 73 when designing a circuit of the power source board 61. Accordingly, it is possible to suppress an increase in costs of the parts of the power source board 61 and to achieve a long life span thereof.

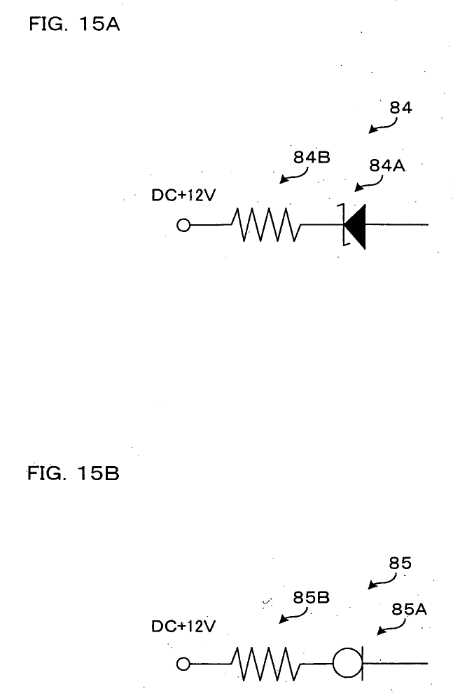

Additionally, as shown in FIG. 15A, a voltage restrictor 84 (driving voltage restricting means) having a Zener diode 84A and a resistance 84B connected to each other in series is provided to a middle of the power supply route, particularly, input sides of the respective boards to which the power is supplied. In case that an applied voltage is in a reverse direction, the Zener diode 84A is under yield state at a specific voltage and exhibits a nearly constant voltage even though the current is varied. In addition, a value of the resistance 84B is determined by a voltage applied to the voltage restrictor 84 and constant voltage and current which are desired to obtain in the Zener diode 84A (12V in this embodiment). Thereby, it is possible to enable a voltage passing to the voltage restrictor 84 not to have a value more than a predetermined value. Accordingly, for example, even though a voltage is rapidly increased due to an illegal act, a static electricity and the like, a voltage of a predetermined value or more is not allowed to flow, so that an erroneous operation or failure can be prevented.

In addition, although it is shown that the voltage restrictor 84 is provided to the input sides of the respective boards to which the power is supplied, the voltage restrictor may be provided to output sides of the respective boards. Additionally, a current restrictor 85 restricting a current value (driving current restricting means) may be further provided at the vicinity of the voltage restrictor 84 so that the erroneous operations and the like can be further prevented. In other words, as shown in FIG. 15B, the current restrictor 85 having a current regulative diode (CRD) 85A and a resistance 85B connected to each other in series may be provided to a middle of the power supply route, particularly, the input sides of the respective boards to which the power is supplied. The CRD 85A is a device having a characteristic of supplying a constant current from a low voltage to a high voltage. Also in this case, it is possible to prevent erroneous operations of the rotary reels 3L, 3C, 3R, the liquid crystal display device 5 and the like to which the power is supplied from the main control board 71 and the sub-control board 73. In addition, the voltage restrictor 84 may be provided to an input side of the power source board 61, i.e., a power supply route between the power source board 61 and the power source 65, as power source voltage restriction means. In this case, it is possible to prevent erroneous operations of the main control board 71 and the sub-control board 73 resulting from the erroneous operation of the power source board 61.

The gaming machine 1 structured as described above exhibits five gaming states consisting of “normal gaming state”, “BB internal winning state”, “RB internal winning state”, “BB normal gaming state” and “RB gaming state”. Each of the “five gaming states” is basically discriminated by kinds of combinations which can be internally won, types of bonuses capable of realizing a winning and a relationship between the internal winning and the winning realization. In the mean time, although it is structured that a bonus to be carried over can be won in case that games of a predetermined number are played, in this embodiment, the invention is not limited thereto and may be properly set. In addition, in this embodiment, during a period after an internal winning is made in a bonus at the normal gaming state and the internal winning state until a winning of the bonus is realized, the bonus is maintained as a winning combination (in general, it is referred to as “carry over” or “carry over state”).

Herein, it is referred a gaming state occurring with the opportunity of the winning realization of BB and consisting of the “BB normal gaming state” and “RB gaming state”, as “BB gaming state”. In addition, the “BB internal winning state” and “RB internal winning state” are states at which an internal winning is made in a bonus and generically referred to as “internal winning state.” In the mean time, the “internal winning state” comprises a state carrying over a bonus.

When “Blue 7-Blue 7-Blue 7” or “Red 7-Red 7-Red 7” is arranged along an activated line under “internal winning state”, a winning of BB is realized and 15 medals can be obtained. More specifically, “Transparency 7-Transparency 7-Transparency 7” is arranged and it becomes “Blue 7-Blue 7-Blue 7” or “Red 7-Red 7-Red 7” by the LED lamp 29. After the winning of BB is realized, the gaming state becomes the “BB normal gaming state.”

In addition, when “Red 7-Red 7-Red 7” is arranged along an activated line under “internal winning state”, or “Replay-Replay-Replay” is arranged under “BB normal gaming state”, a winning of RB is realized and 15 medals can be obtained. It is generally referred the realization of the RB winning under BB normal gaming state as “JAC IN.” After the winning of RB is realized, the gaming state becomes the RB gaming state.

Additionally, it is structured such that a winning of a bonus is not realized in a game in which an internal winning is made in a bonus (except “JAC IN”), irrespective of the gaming states. In addition, in case that the internal winning is made in a bonus under normal gaming state, it is shifted to a separate gaming state in a next game. Accordingly, a winning of a bonus is not realized under normal gaming state.

When “Replay-Replay-Replay” is arranged under BB normal gaming state and internal winning state, a winning of a re-game is realized. When the winning of the re-game is realized, the same number of medals as that of the inserted medals is automatically inserted, so that a player can play a next game without consuming the medals.

In addition, winnings of “Small win of Upper Chili pepper”, “Small win of Lower Chili pepper”, “Small win of Bell” and “Small win of Watermelon” can be realized in the normal gaming state and the BB normal gaming state.

When “Replay-Replay-Replay”, “Red 7-Replay-Replay” and “Blue 7-Replay-Replay” are arranged under RB gaming state, a winning of a single bonus is realized. When the number of the winning realization of the single bonus is “eight times,” or when the twelve times games are over, the gaming state is shifted. Herein, it is generally referred a game of the RB gaming state in which the winning of the single bonus may be made, as “JAC game.”

Hereinafter, in the above structure, an operation of the gaming machine will be described. As shown in FIG. 14, in opening for business or maintenance, the power main switch 66 is operated, so that an AC power for commercial or home use such as AC 100V is supplied to the power source board 61 through a plug of the power source 65. The AC power is rectified and smoothened in the power source board 61 and converted into 12V DC power. The 12V DC power is supplied to the main control board 71 and the sub-control board 73 from the power source board 61, respectively, and used as driving power of the two boards 71, 73. In addition, the 12V DC power is supplied to the external concentration terminal plate 42 from the power source board 61 and used as driving power of the external concentration terminal plate 42.

Like this, since the 12V DC power is supplied to the respective control boards 71, 73 and the external concentration terminal plate 42 from the power source board 61 in a parallel manner, the DC power is not supplied to the sub-control means 73 or the external concentration terminal plate 42 with the voltage being lowered due to a voltage drop in the main control means 71, as the case of supplying the power via the main control board 71 from the power source board 61, for example. As a result of that, even when a voltage of the DC power, which is outputted to the main control board 71 and the sub-control board 73 from the power source board 61, is lowered to 12V which is near to a rated voltage of a lamp used for the effect, it is possible to turn on the lamp with a sufficient brightness, and to surely operate the sub-control board 73 and the liquid crystal display device 5 to which the power is supplied from the sub-control board 73. In addition, it is possible to reduce a false determination in that there occurs a problem in the gaming machine 1, which problem is caused because the DC power is supplied to the external concentration terminal plate 42 with the voltage being lowered and thus the external concentration terminal plate 42 cannot be surely operated, so that the hall computer cannot receive a signal. Further, since it is possible to suppress consumption power of each board such as main control board 71, sub-control board 73, external concentration terminal plate 42 and the like by lowering the voltage to 12V, it is possible to suppress heat generation resulting from the consumption of the power, to prevent an erroneous operation of an electronic circuit of each board caused by the heat and to reduce a running cost.

When the power is supplied to the main control board 71, the sun-control board 73 and the external concentration terminal plate 42 from the power source board 61 in a parallel manner, as described above, the game is not erroneously operated in the main control board 71 and is thud stably executed. At the same time, in the sub-control board 73, the game is not erroneously operated and the effect is thus stably made, based on the various game information such as gaming state and internal winning combination inputted from the main control board 71. Further, it is made a state capable of surely communicating with the hall computer, in the external concentration terminal plate 42. Hereinafter, it will be specifically described a game to be executed in the main control board 71 and an effect to be executed in the sub-control board 73.

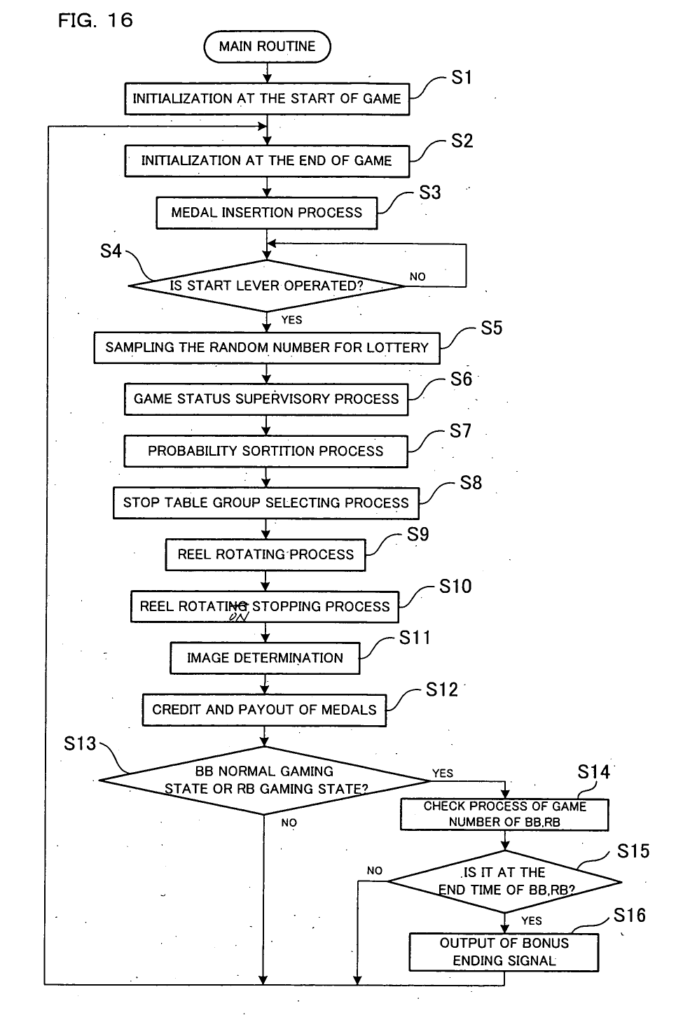

First, a control operation of the CPU 31 of the main control board 71 is described with reference to a main flow chart shown in FIG. 16. First, the CPU 31 performs an initialization at the start of game (step [hereinafter, indicated as S] 1). Specifically, it performs initializations of stored contents of the RAM 33 and the communication data. Subsequently, it erases the predetermined stored contents of the RAM 33 at the end of the game (S2). Specifically, it erases data of a writable area of the RAM 33 which has been used for a previous game, writes a parameter required for a next game to the writable area of the RAM 33 and appoints a start address of a sequence program of the next game. Next, the CPU 31 is under standing-by state until a medal is inserted into the medal insertion slot 22 or there is an input from the BET buttons 11, 12 (S3). Then, it determines whether the start lever 6 has been operated or not (S4).

If the start lever 6 is not operated (S4: NO), it repeats the S4, so that it becomes under input standing-by state. If the start lever 6 is operated (S4: YES), it samples random numbers for lottery (S5). Then, it performs a gaming status supervisory process to check a gaming state of this time game (S6). In other words, the CPU sets a gaming state of this time game as one of the BB normal gaming state, the RB gaming state, the RB internal winning state, the BB internal winning state and the normal gaming state.

Then, it performs a probability sortition process (S7) to determine an internal winning combination, based on the sortition table and the like. When it determines the internal winning combination, the CPU transmits the internal winning combination to the sub-control board 73. Continuously, a stop table group selecting process is carried out (S8). Specifically, the CPU selects a specific stop table group using the kinds of the internal winning combination. The stop table group is used to stop the rotary reels 3L, 3C, 3R in a following S10. It transmits a game starting signal containing the internal winning combination, the gaming state, the information influencing on the stop table group and the like to the sub-control board 73. Continuously, a reel rotating process is performed (S9). Specifically, the CPU rotates the rotary reels 3L, 3C, 3R and transmits a reel stop approving signal to the sub-control board 73 when the rotary reels reach a predetermined speed (for example, constant speed rotation).

Next, a reel rotation stopping process is carried out (S10). In other words, the CPU carries out a sliding-symbol-number deciding process for determining the number of sliding symbols at a timing at which ant one of the stop buttons 7L, 7C, 7R is operated or a timing at which a value of an automatic stop timer becomes “0”. Specifically, it decides the number of sliding symbols, based on the stop table determined (selected) in S9, a stop operation position and a stop control position. The “number of sliding symbols” is the number of symbols moving after the stop buttons are operated until the reels are stopped (it indicates a moving amount (moving distance) of symbol until the reels are stopped). Continuously, it rotates and stops the reels corresponding to the stop buttons which are stop-operated as the number of sliding symbols. In the mean time, whenever the stop buttons 7L, 7C, 7R are operated and thus the corresponding reels are stopped, the CPU transmits the reel stopping signals (left, center, right) to the sub-control board 73. In addition, when all the reels are stopped, it transmits all the reel stopping signals to the sub-control board 73.

Next, the CPU 31 performs a winning determination (S11). The winning determination is meant by discriminating a winning combination (combination having realized the winning), based on stop modes of the nine symbols of the rotary reels discernible with naked eyes through the transmissive liquid crystal panel 54. Specifically, the CPU discriminates the winning combination, based on the code numbers of the symbols arranged along the center line 8c and the winning termination table. Then, it transmits the winning signal to the sub-control board 73. Then, the CPU performs the credit or payout of the obtained medals (S12). Specifically, in case that a medal is obtained through the winning realization, the CPU displays the number of the obtained medals on the payout display unit 18. The player can change the C/P button 14 to select whether the obtained medals are credited in the gaming machine 1 or paid out from the medal payout slot 15. In the mean time, the credited medals may be bet in the next game by pushing the BET buttons 11, 12. Meanwhile, in case that it is determined that the winning combination is the BB or RB, the CPU performs a generation of the BB or RB gaming state.

Next, the CPU determines whether the current gaming state is the “BB normal gaming state” or “RB gaming state” (S13). If the gaming state is not the “BB normal gaming state” or “RB gaming state” (S13: NO), the CPU returns to the S2. If the gaming state is the “BB normal gaming state” or “RB gaming state” (S13: YES), it performs a “game number check process” of the bonuses (BB, RB) (S14). In the “game number check process”, the CPU check s the number of the RB gaming states occurred, the game number of the BB normal gaming state, the winning number in the RB gaming state and the game number in the RB gaming state and performs a shift (setting) of the gaming state between the BB normal gaming state and the RB gaming state.

Next, the CPU determines whether it is at the end time of the bonus (S15). Specifically, after the winning of BB is realized, the CPU determines whether the winning number is eight times or the game number is 12 times in the RB gaming state at third times, or whether the game number is 30 times in the BB normal gaming state or not. In addition, after “Red 7-Red 7-Red 7” is arranged along the activated line and thus the winning of the RB is realized, the CPU determines whether the winning number is eight times or the game number is 12 times in the RB gaming state. As a result of the determination, if it is determined that it is not at the end time of the bonus (S15: NO), the CPU returns to the S2. In the mean time, if it is determined that it is at the end time of the bonus (S15: NO), the CPU outputs a bonus ending signal to the sub-control board 73 (S16) and returns to the S2.

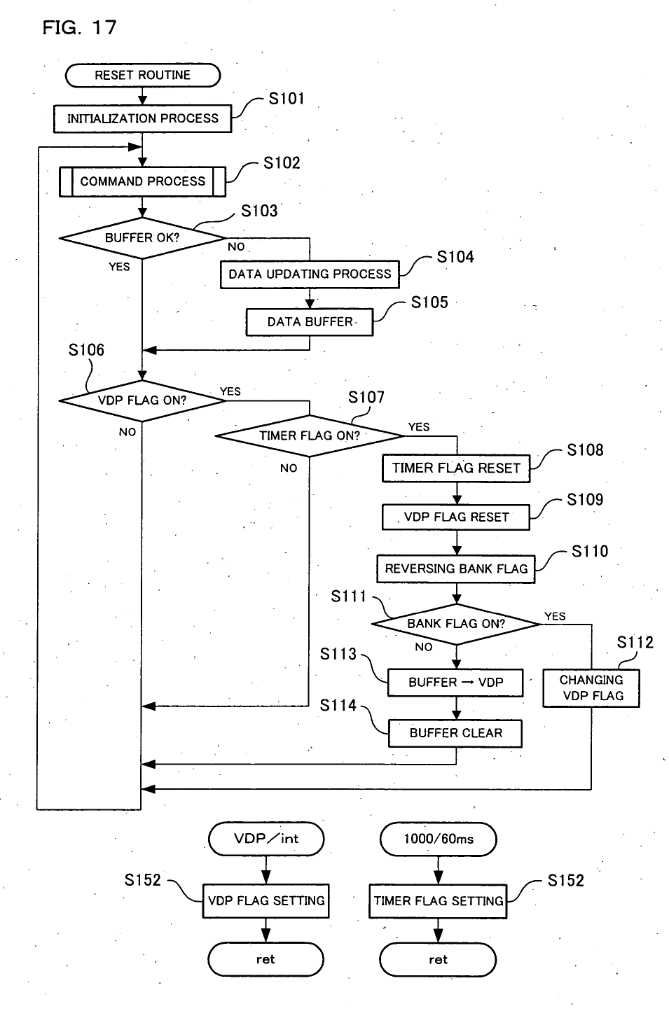

When the main routine of FIG. 16 is carried out in the main control board 71 as described above, the sub-CPU 74 of the sub-control board 73 to which various signals are transmitted from the main control board 71 performs an operation shown in FIG. 17.

In other words, as shown in FIG. 17, when the power is inputted into the sub-control board 73, the sub-CPU 74 independently executes operations of periodically setting a video display processor (VDP) flag and a timer flag. In addition, the sub-CPU 74 performs various process operations at the operating timings using the flags and enables the liquid crystal display device 5 to display a desired moving picture or still picture.

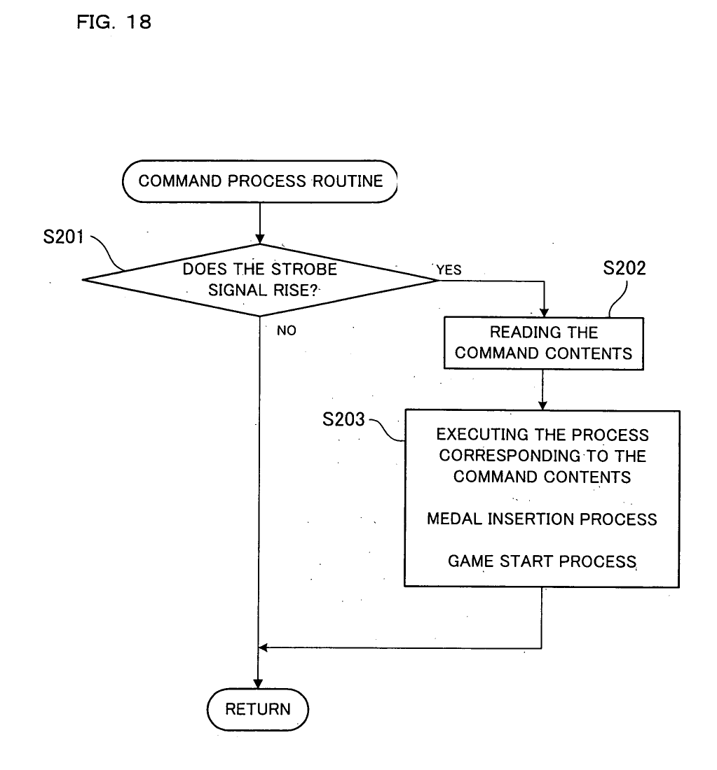

Specifically, when the power is inputted, the sub-CPU clears and initializes the work RAM 76 and the image control work RAM 83 (s101), and executes a command process (S102). In the command process, as shown in FIG. 18, the sub-CPU monitors a state of a strobe signal transmitted from the main control board 71 (S201). If the strobe signal does not rise (S201: NO), the sub-CPU terminates this routine. In the mean time, if the strobe signal rises (S201: YES), the sub-CPU reads a signal transmitted together with the strobe signal in parallel using the rise as a trigger. Then, the sub-CPU reads command contents contained in the signal (S202) to execute various processes such as medal insertion process corresponding to the command contents, so that it prepares a mode to be displayed on the liquid crystal display device 5 through an appointment of an address and the like.

Next, as shown in FIG. 17, the sub-CPU determines whether the image data to be transmitted to the image control work RAM 83 is prepared in the buffer provided in the work RAM 76 (S103). If the buffer is under usable state (S103: YES), the sub-CPU determines whether the timer flag is under OK state or not (S106). If the timer flag is not under OK state (S106: NO), the sub-CPU stands-by an update process of the buffer, until it re-executes the processes after the S102 and thus the image data of the buffer is transmitted to the image control work RAM 83 so that the image data is used in the image control IC 82.

If it is determined that the image data to be transmitted to the image control work RAM 83 is not prepared in the buffer (S103: NO), the sub-CPU updates the data so that it becomes the display mode prepared in the process of S102 (S104). Then, the sub-CPU writes the updated image data into the buffer (S105) and determines whether the timer flag, which becomes ON state with a period of 1000/60 ms, is under ON state or not (S106), so that the mode to be displayed on the liquid crystal display device 5 is changed with a period having a predetermined extent or more.

If the timer flag becomes the ON state (S106: YES) as a result that the timer flag is set at the intervention timing of 1000/60 ms in the sub-CPU 74, the sub-CPU continues to determine whether the VDP flag is under ON state, thereby determining whether the image control IC 82 is under operable state (S107). If the VDP flag is not under ON state (S107: NO), the sub-CPU determines that the VDP (=image control IC 82)) is under busy state and stands-by, until it re-executes the processes after the S102 and thus the VDP flag is changed into the ON state. In the mean time, if the VDP flag is under ON state (S107: YES) as a result that the VDP flag is set by an intervention signal from the VDP resulting from the shift of the VDP (=image control IC 82)) to an idle state (S151), the sub-CPU resets the timer flag (S108) and the VDP flag (S109) at the same time. Thereby, until the timer flag and the VDP flag are set in the next intervention processes (S151, S152), it is not updated the image data of the image control work RAM 83, which is transmitted from the buffer to be performed later (S113) and thus generated, or a bank to be changed in a VDP bank conversion (S112).

Next, the sub-CPU changes on/off of a bank flag into a reverse value to a current bank flag, which the bank flag is provided to select which one of processes of alternately changing two data areas (banks) secured in the video RAM 87 and transmitting the image data to the image control work RAM 83 is performed. In other words, the sub-CPU reverses the bank flag (S110) and determines whether the bank flag after the reverse is under ON state (S111). Then, if it is under ON state (S111: YES), the sub-CPU commands the VDP (=image control IC 82) to change into another bank (S112) and changes the display image. Specifically, the VRAM is provided with two data areas, i.e., bank (0) and bank (1) and the controlled state of each bank before the change is as follows: the bank (0) is controlled to display an image corresponding to the lo stored image data to the player, and the bank (1) stands by under state that the image data starting to be prepared from before 1000/60 ms is completely stored and can be displayed to the player. Next, the VDP having received the command of the bank change performs a conversion control so that the image corresponding to the image data stored in the bank (0) and currently displayed to the player cannot be discernible with naked eyes for the player and the image corresponding to the image data stored in the bank (1) which has been already completely prepared to be displayed to the player is displayed to the player. Then, the sub-CPU re-executes the processes after the S102.

In addition, if the bank flag is not under ON state (S111: NO), the sub-CPU transmits the image data stored in the buffer of the work RAM 76 to the image control work RAM 83 (S113). The image control IC 82 stores the image data of the image control work RAM 83, which is transmitted under control of the sub-CPU 74, into a bank different from the bank in which the image data corresponding to the image currently displayed is stored. The image corresponding to the stored image data is displayed to the player through the bank change to be performed after 1000/60 ms. Like this, the image data storing and the bank change of the VDP are alternately carried out every 1000/60 ms, so that the blinking of the screen display on the liquid crystal display device 5 is prevented. Then, the sub-CPU clears the buffer (S114) and re-executes the processes from the S102. The sub-CPU repetitively performs the processes from S102 to S114 using the VDP flag or timer flag to display the image such as moving picture or still picture resulting from the command process of S102 on the liquid crystal display device 5.

During the operations, the game information (for example, medal insertion or BB winning) signal and the like is transmitted to the external concentration terminal plate 42 from the main control board 71. In addition, the power is transmitted from the power source board 61, so that the external concentration terminal plate 42 is operated. As described above, the signal from the main control board 71 is transmitted to the hall computer via the relay of the external concentration terminal plate 42, and the power is supplied, so that the contact point of the relay is closed and thus the signal can be transmitted. For example, when the medal is inserted into the medal insertion slot 22 of the gaming machine 1, a detection signal is transmitted to the main control board 71 from the medal insertion switch 22A and further to the external concentration terminal plate 42 from the main control board 71. When the external concentration terminal plate 42 receives the signal, it transmits the signal to the hall computer. Thereby, by receiving the signal from the external concentration terminal plate 42, the hall computer can determine that the gaming machine 1 Is normally operated. In addition, if the hall computer does not receive the signal from the external concentration terminal plate 42 for a predetermined period, since it is high a possibility that there occurs a problem in the power source board 61 or the main control board 71 of the gaming machine 1 having the external concentration terminal plate 42, it is possible to cope with the problem at an early stage.

When the game and the effect are repetitively performed through the main routine of FIG. 16 and the like as described above, if it is carried out an illegal act applying a high voltage at the output side of the power source board 61 from the exterior, as shown in FIG. 8, the high voltage is restricted to predetermined voltage and current by the voltage restrictor 84 before it is applied to the main control board 71 and the sub-control board 73. Specifically, as shown in FIG. 15, if the high voltage is applied, the Zener diode 84A of the voltage restrictor 84 restricts the high voltage to a predetermined voltage and supplies the power of the restricted voltage to the main control board 71 and the sub-control board 73. In addition, in case that the current restrictor 85 is provided, when the high voltage is applied, the current regulative diode (CRD) 85A of the current restrictor 85 restricts the high voltage to a predetermined current and supplies the power of the restricted current to the main control board 71 and the sub-control board 73. Thereby, the high voltage is restricted to a predetermined voltage or less by the voltage restrictor 84 or the current restrictor 85 and at the same time the high current is restricted to a predetermined current or less, so that it is possible to prevent the illegal act resulting from the erroneous operations of the main control board 71 and the sub-control board 73 due to the high voltage or high current. In addition to the illegal act, it is also possible to an erroneous operation resulting from a surge voltage due to a static electricity. Further, it is possible to prevent a problem in that false data is transmitted to the hall computer through the external concentration terminal plate to cause a trouble in management.

In addition, in case that the game and the effect are repetitively performed as described above and thus it is required an update of the power source board 61, the power source box 60 is opened as shown in FIG. 1. In addition, as shown in FIG. 7, in case the it is required an update of the main power source unit 61A, the block-type main power source unit 61A is extracted from the socket 61S and exchanged and replaced with a new main power source unit 61A. At this time, the main power source unit. 61A and the sub-power source unit 61B are colored so that they can be discriminated from each other. For example, the main power source unit 61A is colored with a blue color and the sub-power source unit 61B is colored with a red color. Accordingly, since the confusion with the sub-power source unit 61B is prevented during the update of the main power source unit 61A, it is possible to prevent a delay of the update operation resulting from operation mistakes. In the mean time, the handling prevention of the main power source unit 61A and the sub-power source unit 61B is also effective for the manufacturing of the power source board 61.

As described above, the gaming machine according to the embodiment of the invention is provided with the symbol display means (for example, rotary reels 3L, 3C, 3R) capable of variably displaying a plurality of symbols, the main control means (for example, main control board 71) for supplying the power to the symbol display means, controlling states from a beginning of the variable display of the symbols to a stopping thereof in the symbol display means and carrying out a game providing a game value (for example, medal), based on the symbol after the stopping, the effect means (for example, liquid crystal display device 5) for effecting a game, the sub-control means (for example, sub-control board 73) for supplying the power to the effect means and controlling the effect, and the power source means (for example, power source board 61) for supplying the power to the main control means and the sub-control means, respectively.

According to the above structure, since the power is respectively supplied to the main control means and the sub-control means from the power source means, the power is not supplied to the sub-control means with a voltage being lowered due to a voltage drop in the main control means, as the case of supplying the power to the sub-control means via the main control means from the power source means, for example. Thereby, even when a voltage of the power, which is outputted to the main control means and the sub-control means from the power source means, is lowered, it is possible to surely operate the sub-control means and the effect means to which the power is supplied from the sub-control means. In addition, since it is possible to suppress consumption power of each means such as main control means, sub-control means or the like if the voltage is lowered, it is possible to suppress a heat generation resulting from the consumption of the power, to prevent an erroneous operation of each means caused by the heat and to reduce a running cost.

Further, since it is structured a power supply route of supplying the power to the main control means and the sub-control means from the power source means, respectively, then supplying the power to the symbol display means from the main control means and supplying the power to the effect means from the sub-control means at the same time, it is possible to simplify a wiring or circuit arrangement as compared to a power supply route of supplying the power to all the means from the power source means.

In addition, according to an embodiment of the invention, the gaming machine 1 comprises the game value payout means (for example, hopper 40) for paying out a game value and the main control means may be structured in such a way that it supplies the power to the game value payout means and controls the game value payout means to pay out the game value. According to this structure, since the game value payout means is operated through the power supply from the main control means, it is possible to simplify a circuit structure as compared to case of supplying the power to the game value payout means from the power source means.

In addition, the gaming machine according to the embodiment of the invention is provided with the symbol display means (for example, rotary reels 3;, 3C, 3R) capable of variably displaying a plurality of symbols, the main control means (for example, main control board 71) for supplying the power to the symbol display means, controlling states from a beginning of the variable display of the symbols to a stopping thereof in the symbol display means and carrying out a game providing a game value based on the symbol after the stopping, the effect means (for example, liquid crystal display device 5) for effecting a game, the sub-control means (for example, sub-control board 73) for supplying the power to the effect means and controlling the effect, the power source means (for example, power source board 61) for supplying the power to the main control means and the sub-control means, respectively, and the driving voltage restriction means (for example, voltage restrictor 84) provided to at least the input sides of the power supplied to the main control means and the sub-control means, respectively, and restricting a voltage of the power to a predetermined level or less.

According to the above invention, even when it is carried out an illegal act which forcibly applies a high voltage at an output side of the power source means from the exterior to cause an erroneous operation of the main control means or sub-control means, the high voltage is restricted to the predetermined level or less by the driving voltage restriction means, so that it is possible to prevent the illegal act resulting from the erroneous operations of at least the main control means and the sub-control means at the high voltage. In addition to the illegal act, it is also possible to an erroneous operation resulting from a surge voltage due to a static electricity.

Further, since the power is respectively supplied to the main control means and the sub-control means from the power source means, the power is riot supplied to the sub-control means with the voltage being lowered due to a voltage drop in the main control means, as the case of supplying the power to the sub-control means via the main control means from the power source means, for example. Thereby, even when a voltage of the power, which is outputted to the main control means and the sub-control means from the power source means, is lowered, it is possible to surely operate the sub-control means and the effect means to which the power is supplied from the sub-control means. In addition, since it is possible to suppress consumption power of each means such as main control means, sub-control means or the like if the voltage is lowered, it is possible to suppress heat generation resulting from the consumption of the power, to prevent an erroneous operation of each means caused by the heat and to reduce a running cost. Additionally, since it is structured a power supply route of supplying the power to the main control means and the sub-control means from the power source means, respectively, then supplying the power to the symbol display means from the main control means and supplying the power to the effect means from the sub-control means at the same time, it is possible to simplify a wiring or circuit arrangement as compared to a power supply route of supplying the power to all the means from the power source means.

In addition, according to an embodiment of the invention, the gaming machine comprises the driving current restriction means (for example, current restrictor 85) provided to at least the input sides of the power supplied to the main control means and the sub-control means and restricting the current of the power to a predetermined level or less. According to this structure, since the power having the current of the predetermined level or less is supplied to the main control means and the sub-control means, it is possible to prevent the erroneous operation due to the illegal act or static electricity, even more surely.

Further, the power source means of the invention may be structured such that the power, which is respectively supplied to the main control means and the sub-control means, is set with the same voltage of 12V. According to this structure, since the power having the same voltage of 12V is respectively supplied to the main control means and the sub-control means, it is possible to simplify the circuit structure of the power source means. In addition, it is possible to prevent deterioration of the circuit device, as compared to a case that the power with the voltage of 24V is supplied. Additionally, although the main control means and the sub-control means are liable to erroneously operate when the voltage is 12V, as compared to the voltage of 24V, since the excessive voltage variance is prevented by at least the driving voltage restriction means, the erroneous operation due to the voltage variance can be sufficiently prevented.

In addition, the gaming machine according to an embodiment of the invention is provided with the symbol display means (for example, rotary reels 3L, 3C, 3R) capable of variably displaying a plurality of symbols, the main control means (for example, main control board 71) for supplying power to the symbol display means, controlling states from a beginning of the variable display of the symbols to a stopping thereof in the symbol display means and carrying out a game providing a game value based on the symbol after the stopping, the effect means (for example, liquid crystal display device 5) for effecting a game, the sub-control means (for example, sub-control board 73) for supplying the power to the effect means and controlling the effect, the external concentration terminal plate (for example, the external concentration terminal plate 42) having a contact unit capable of opening and closing a point of contact by power supply and making it possible to transmit and receive various signals to and from the hall computer via the contact unit, the power source means (for example, power source board 61) for supplying the power to the main control means, the sub-control means and the external concentration terminal plate, respectively, and the driving voltage restriction means (for example, voltage restrictor 84) provided to at least the input sides of the power supplied to the main control means, the sub-control means and the external concentration terminal plate, respectively, and restricting a voltage of the power to a predetermined level or less.

According to the above structure, even when it is carried out an illegal act which forcibly applies a high voltage at an output of the power source means from the exterior to cause an erroneous operation of the main control means, the sub-control means or the external concentration terminal plate, the high voltage is restricted to the predetermined level or less by the driving voltage restriction means, so that it is possible to prevent the illegal act resulting from the erroneous operations of at least the main control means, the sub-control means and the external concentration terminal plate at the high voltage. In addition to the illegal act, it is also possible to an erroneous operation resulting from a surge voltage due to a static electricity. In particular, it is possible to prevent a problem in that false data is transmitted to a hall computer through the external concentration terminal plate to cause a trouble in management.

Further, since the power is respectively supplied to the main control means, the sub-control means and the external concentration terminal plate from the power source means, the power is not supplied to the sub-control means with the voltage being lowered due to a voltage drop in the main control means, as the case of supplying the power to the sub-control means via the main control means from the power source means, for example. Thereby, even when a voltage of the power, which is outputted to the main control means and the sub-control means from the power source means, is lowered, it is possible to surely operate the sub-control means and the effect means to which the power is supplied from the sub-control means. In addition, since it is possible to suppress consumption power of each means such as main control means, sub-control means, external concentration terminal plate and the like if the voltage is lowered, it is possible to suppress heat generation resulting from the consumption of the power, to prevent an erroneous operation of each means caused by the heat and to reduce a running cost.

Additionally, since it is structured a power supply route of supplying the power to the main control means and the sub-control means from the power source means, respectively, then supplying the power to the symbol display means from the main control means and supplying the power to the effect means from the sub-control means at the same time, it is possible to simplify a wiring or circuit arrangement as compared to a power supply route of supplying the power to all the means from the power source means.

In addition, according to the embodiment of the invention, the gaming machine comprises the driving current restriction means (for example, current restrictor 85) provided to at least the input sides of the power supplied to the main control means, the sub-control means and the external concentration terminal plate, respectively and restricting the current of the power to a predetermined level or less. According to this structure, since the power having the current of the predetermined level or less is supplied to the main control means, the sub-control means and the external concentration terminal plate, it is possible to prevent the erroneous operation due to the illegal act or static electricity, even more surely.

Further, according to an embodiment of the invention, at least one of the driving voltage restriction means and the driving current restriction means is equipped at the output sides of the main control means and the sub-control means. According to this structure, it is possible to prevent the erroneous operations of the symbol display means and the effect means to which the power is supplied from the main control means and the sub-control means.

According to an embodiment of the invention, there is provided the power source restriction means (for example, the voltage restriction means 84) for restricting the voltage of the power supplied to the power source means to a predetermined level or less. According to this structure, it is also possible to prevent the erroneous operation of the main control means or the sub-control means, which results from the erroneous operation of the power source means.

In addition, according to an embodiment of the invention, the gaming machine comprises the symbol display means (for example, rotary reels 3L, 3C, 3R) capable of variably displaying a plurality of symbols, the main control means (main control board 71) for supplying power to the symbol display means, controlling states from a beginning of the variable display of the symbols to a stopping thereof in the symbol display means and carrying out a game providing a game value based on the symbol after the stopping, the effect means (liquid crystal display device 5) for effecting a game, the sub-control means (sub-control board 73) for supplying the power to the effect means and controlling the effect, and the power source means (for example, power source board 61) having a main control power source unit (for example, main power source unit 61A) and a sub-control power source unit (for example, sub-power source unit 61B) for independently supplying the power to the main control means and the sub-control means and the external concentration terminal plate, respectively.

According to the above structure, since the power is independently supplied to the main control means and the sub-control means from the power source means, respectively, the power is not supplied to the sub-control means with the voltage being lowered due to a voltage drop in the main control means, as the case of supplying the power to the sub-control means via the main control means from the power source means, for example. Thereby, even when a voltage of the power, which is outputted to the main control means and the sub-control means from the power source means, is lowered, it is possible to surely operate the sub-control means and the effect means to which the power is supplied from the sub-control means. In addition, since it is possible to suppress consumption power of each means such as main control means, sub-control means and the like if the voltage is lowered, it is possible to suppress heat generation resulting from the consumption of the power, to prevent an erroneous operation of each means caused by the heat and to reduce a running cost.

Additionally, since it is structured a power supply route of supplying the power to the main control means and the sub-control means from the power source means, respectively, then supplying the power to the symbol display means from the main control means and supplying the power to the effect means from the sub-control means at the same time, it is possible to simplify a wiring or circuit arrangement as compared to a power supply route of supplying the power to all the means from the power source means.

In addition, since the power source means is divided into the main control power source unit and the sub-control power source unit, it is possible to select optimal parts according to each consumption power of the main control means and the sub-control means when designing a circuit of the power source means. Accordingly, it is possible to suppress an increase in costs of the parts of the power source means and to achieve a long life span thereof.

Further, the power source means of the embodiment is such structured that the power, which is respectively supplied to the main control means and the sub-control means, is set with the same voltage of 12V. According to this structure, since the power having the same voltage of 12V is respectively supplied to the main control means and the sub-control means, it is possible to simplify the circuit structure of the power source means. In addition, it is possible to prevent deterioration of the circuit device realizing a long span of the power source means, as compared to a case that the power with the voltage of 24V is supplied.

In addition, according to an embodiment of the invention, the main control power source unit and the sub-control power source unit are formed into a block-type so that they can be detachable. According to this structure, in case that the consumption power is changed due to the specification changes of each means such as main control means, sub-control means and the like or that the power source means gets out of order, it is possible to update the power source means by the simple operation of replacing the block-type main control power source unit and the block-type sub-control power source unit. In addition, in case that the consumption power of only one of the main control means and the sub-control means is changed, since it has only to change the power source unit to be replaced, it is possible to reduce the update cost of the power source means.

In addition, according to an embodiment of the invention, the main control power source unit and the sub-control power source unit are structured such that the block types thereof can be discriminated from each other. According to this structure, since it is possible to discriminate the block types of the main control power source unit and the sub-control power source unit, it is possible to prevent the operation mistakes that the main control power source unit and the sub-control power source unit are erroneously mounted.

Further, according to an embodiment of the invention, at least one of the driving voltage restriction means (for example, voltage restrictor 84) for restricting the voltage to a predetermined level or less and the driving current restriction means (for example, current restrictor 85) for restricting the current to a predetermined level or less is provided to the power input sides of the main control means and the sub-control means, respectively. According to this structure, since the power having the voltage or current of the predetermined level or less is supplied to the main control means and the sub-control means, it is possible to prevent the erroneous operation due to the illegal act, the static electricity or the like.

The embodiments of the invention as set forth above are intended to be illustrative, not limiting. In other words, although each board constituting the gaming machine 1 has been specifically described in the above embodiments, it is not limited thereto. For example, the door relay board 70 and the reel board 47 may be constituted with a same board. In addition, although the power source supervisory means 82 consists of the Zener diode and the resistance in the embodiments, it may be constituted with separate devices and the voltage restriction value may not be 12V. In addition, the power may be directly supplied to the external concentration terminal plate 42 from the power source board 61.

In addition, although the power source board 61 comprises the main power source unit 61A and the sub-power source unit 61B and supplies the power the main control board 71 and the sub-control board 73, respectively in the embodiments, a single power source unit may supply the power. Further, the power may be supplied to the external concentration terminal plate 42 from the main control board 71. In addition, although it has been described the gaming machine as a pachi-slot machine in the embodiments, it is needless to say that the gaming machine may be other gaming machines as well as the pachi-slot machine.

Other specific structures may be properly design-changed and the above embodiments may be properly combined. In the mean time, the operations and the effects described in the embodiments are only enumerations of the most suitable operations and effects obtainable from the invention and the operations and effects of the invention are not limited to the embodiments.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
symbol display means capable of variably displaying a plurality of symbols;
main control means for supplying power to the symbol display means, controlling states from a beginning of the variable display of the symbols to a stopping thereof in the symbol display means and carrying out a game providing a game value based on the symbol after the stopping;
effect means for effecting a game;
sub-control means for supplying the power to the effect means and controlling the effect; and
power source means for supplying the power to the main control means and the sub-control means, respectively.

2. The gaming machine according to claim 1, wherein the power source means is such structured that the power, which is respectively supplied to the main control means and the sub-control means, is set with a same voltage of 12V.

3. The gaming machine according to claim 1, further comprising game value payout means for paying out the game value, wherein the main control means supplies the power to the game value payout means and controls the game value payout means to pay out the game value.

4. A gaming machine comprising:
symbol display means capable of variably displaying a plurality of symbols;
main control means for supplying power to the symbol display means, controlling states from a beginning of the variable display of the symbols to a stopping thereof in the symbol display means and carrying out a game providing a game value based on the symbol after the stopping;
effect means for effecting a game;
sub-control means for supplying the power to the effect means and controlling the effect;
power source means for supplying the power to the main control means and the sub-control means, respectively; and
driving voltage restriction means provided to at least input sides of the power supplied to the main control means and the sub-control means, respectively, and restricting a voltage of the power to a predetermined level or less.

5. The gaming machine according to claim 4, further comprising driving current restriction means provided to at least input sides of the power supplied to the main control means and the sub-control means, respectively, and restricting a current of the power to a predetermined level or less.

6. The gaming machine according to claim 4, wherein at least one of the driving voltage restriction means and the driving current restriction means is also provided to output sides of the power of the main control means and the sub-control means.

7. The gaming machine according to claim 4, further comprising power source voltage restriction means provided to an input side of the power source means and restricting a voltage of the power supplied to the power source means to a predetermined level or less.

8. The gaming machine according to claim 4, wherein the power source means is such structured that the power, which is respectively supplied to the main control means and the sub-control means, is set with a same voltage of 12V.

9. A gaming machine comprising:
symbol display means capable of variably displaying a plurality of symbols;
main control means for supplying power to the symbol display means, controlling states from a beginning of the variable display of the symbols to a stopping thereof in the symbol display means and carrying out a game providing a game value based on the symbol after the stopping;
effect means for effecting a game;
sub-control means for supplying the power to the effect means and controlling the effect;
an external concentration terminal plate having a contact unit capable of opening and closing a point of contact by power supply and making it possible to transmit and receive various signals to and from a hall computer via the contact unit;
power source means for supplying the power to the main control means, the sub-control means and the external concentration terminal plate, respectively; and
driving voltage restriction means provided to at least input sides of the power supplied to the main control means, the sub-control means and the external concentration terminal plate, respectively, and restricting a voltage of the power to a predetermined level or less.

10. The gaming machine according to claim 9, further comprising driving current restriction means provided to at least input sides of the power supplied to the main control means, the sub-control means and the external concentration terminal plate, respectively, and restricting a current of the power to a predetermined level or less.

11. The gaming machine according to claim 9, wherein at least one of the driving voltage restriction means and the driving current restriction means is also provided to output sides of the power of the main control means and the sub-control means.

12. The gaming machine according to claim 9, further comprising power source voltage restriction means provided to an input side of the power source means and restricting a voltage of the power supplied to the power source means to a predetermined level or less.

13. The gaming machine according to claim 9, wherein the power source means is such structured that the power, which is respectively supplied to the main control means, the sub-control means and the external concentration terminal plate, is set with a same voltage of 12V.

14. A gaming machine comprising:
symbol display means capable of variably displaying a plurality of symbols;
main control means for supplying power to the symbol display means, controlling states from a beginning of the variable display of the symbols to a stopping thereof in the symbol display means and carrying out a game providing a game value based on the symbol after the stopping;
effect means for effecting a game;
sub-control means for supplying the power to the effect means and controlling the effect; and
power source means having a main control power source unit and a sub-control power source unit for independently supplying the power to the main control means and the sub-control means, respectively.

15. The gaming machine according to claim 14, wherein the power source means is such structured that the power, which is respectively supplied to the main control means and the sub-control means, is set with a same voltage of 12V.

16. The gaming machine according to claim 14, wherein the main control power source unit and the sub-control power source unit are formed into a block-type so that they are detachable.

17. The gaming machine according to claim 14, wherein the main control power source unit and the sub-control power source unit are such structured that the block types thereof are able to be discriminated.

18. The gaming machine according to claim 14, wherein at least one of driving voltage restriction means for restricting a voltage to a predetermined level or less and driving current restriction means for restricting a current to a predetermined level or less is respectively provided to power input sides of the main control means arid the sub-control means.
